(19) United States
(12) Patent Application Publication
(10) Pub. No.: US 2025/0206926 A1
(43) Pub. Date: Jun. 26, 2025

(54) RUBBER COMPOSITION FOR AN INNER LINER FOR PNEUMATIC VEHICLE TIRES

(71) Applicant: Suncoal Industries GmbH, Ludwigsfelde (DE)

(72) Inventors: Gerd Schmaucks, Ludwigsfelde (DE); Bernhard Schwaiger, Erftstadt (DE); Alexander Stücker, Hamburg (DE)

(73) Assignee: Suncoal Industries GmbH, Ludwigsfelde (DE)

(21) Appl. No.: 18/848,318

(22) PCT Filed: Mar. 22, 2023
(86) PCT No.: PCT/EP2023/057384

§ 371 Date: Sep. 18, 2024

(30) Foreign Application Priority Data
Mar. 22, 2022 (EP) 22163525.3

(51) Int. Cl. C08L 15/02; B60C 1/00; C08J 3/20; C08J 3/22; C08J 3/24; C08K 3/04; C08K 3/06; C08K 3/22; C08K 5/09; C08K 5/45

(52) U.S. Cl. CPC C08L 15/02; B60C 1/0008; C08J 3/203; C08J 3/22; C08J 3/247; C08K 3/04; C08K 3/06; C08K 5/09; C08K 5/45; C08J 2315/02; C08J 2407/00; C08K 2003/2296; C08K 2201/005; C08K 2201/006; C08L 2205/025; C08L 2310/00; C08L 2312/02

(57) ABSTRACT

A rubber composition comprises a rubber component that comprises at least one halobutyl rubber in an amount from 60 to 100 phr and a filler component that comprises fillers F1 having ¹⁴C content of 0.20 to 0.45 Bq/g of carbon; carbon content of 60 wt. % to 85 wt. %; acidic hydroxy groups on their surface; wherein weighted arithmetic average of STSA of F1 is from 40 m²/g to 80 m²/g; F1 have a volume-based median particle size distribution from 0.5 μm to 5 μm and a volume-based value from 3 μm to 23 μm; and (i) the filler component comprises more than 45 phr of F1; or (ii) the filler component comprises more than 25 phr of F1 and additionally comprises one or more industrial carbon blacks F2, wherein weighted arithmetic average of STSA of the F2 is 55 m²/g to 95 m²/g.

### FIELD OF THE INVENTION

The invention relates to rubber compositions, more particularly to vulcanizable and vulcanized rubber compositions for inner liners of pneumatic vehicle tires. The invention further relates to a kit of parts for the manufacture thereof and methods for the manufacture and further processing thereof, as well as a method for manufacturing of pneumatic tires. The invention further relates to the use of special fillers made of regrowing raw materials for the preparation of the rubber compositions, in particular for inner liners.

### BACKGROUND OF THE INVENTION

Pneumatic vehicle tires have a complex structure. Correspondingly, the demands placed on them are diverse. On the one hand, short braking distances must be ensured on dry and wet roads, and they must have good abrasion properties and low rolling resistance on the other hand. In addition, the vehicle tires must comply with the requirements of the legislator.

To ensure such a diverse performance profile, the individual tire components are specialized and consist of a plurality of different materials, such as metals, polymer textile materials and various rubber-based components.

Depending on the design of the pneumatic tires, a distinction is made between radial tires, cross-ply tires and bias-ply tires or bias-belted tires. A typical pneumatic tire, as an example a radial-ply belted tire, comprises at least a belt, a belt cover, a tread, reinforcing strips, sidewalls, bead fillers, bead wires, an inner liner and a carcass.

The belt usually consists of layers of stranded steel wire that are rubber-coated and angularly disposed. Its main purpose is to provide structural strength to the tire in its air-filled state. The belt further provides for driving stability during acceleration, braking and cornering. It influences the rolling resistance and significantly contributes to the tire's mileage.

The belt overlay located between the tread and the upper belt serves for improving high-speed performance and limits the tire diameter at increasing speed.

The tread is essentially responsible for the driving characteristics. The rubber compound of the treads determines the abrasion characteristics and the dynamic driving characteristics in different weather conditions (on wet and dry roads, in cold and warm weather, on ice and snow). The design of the tread pattern, in turn, is largely responsible for the tire's behavior in case of aquaplaning and wet conditions as well as on snow, and also determines its noise behavior.

Reinforcing strips are optionally used in the region of the bead filler to further improve the strength of the tire as well as the driving characteristics.

The sidewall protects the carcass against lateral damage and atmospheric influences. The rubber compound for the sidewall is flexible and abrasion-resistant and contains relatively large quantities of aggregates for protection against aging and ozone.

The bead filler rides on the bead wire/bead core. Its form and configuration provide driving stability and have an influence on the steering precision and the suspension comfort. Rubber compounds for bead fillers are typically very strong and relatively hard, which is ensured, among other things, by a high degree of crosslinking using highly dosed vulcanization systems and by the selection of the fillers.

The bead wire is the inner part of the tire bead and consists of stranded steel wires coated with rubber that are annularly coiled and hold the tire stably on the rim. In the common tubeless configuration, the tire bead (also called tire base or foot) presses against the rim flange and closes the tire in an airtight manner. The steel cords and wires in the bead core, the tread or in the carcass of the full steel tire must firmly connect with the surrounding rubber compound in order to act as a composite. For that purpose, the steel wires are often coated with brass or bronze. Only thereafter they are formed, using a wire bonding compound, into tire building parts which in turn are assembled to form a tire blank. Wire bonding compounds are relatively strong, crack resistant due to their high proportion of natural rubber and achieve a strong connection to the brass or bronze coating, for example by special resin additives and a high sulfur content. The permanent connection is formed during vulcanization.

The carcass forms the basic structure of the tire and consists of one or more textile fabric layers (Rayon, Nylon, polyester, aramid) or steel cord layers (for trucks) that are embedded in rubber. The carcass is put under tension by means of the tire air pressure and is therefore substantially responsible for the transmission of forces, between the rim and the tread/street. It is connected to the tire bead in the tire base and thus holds the tire together. The carcass works as a composite between the cord layers which warrant for the strength and the transmission of forces and a rubber compound that encloses the parallel cords. Because of the constant deformation of the tire, the cord compound has to be fatigue-resistant, which is most often achieved by a blend of natural rubber and synthetic rubbers, but it also has to form a firm connection with the cords. For this purpose, the cords are coated with a rubber compound after stranding/twisting. The cords having that finishing are coated with the unvulcanized rubber compound. Resin systems in the special compounds then react with the cord finishing during vulcanization to form a durable composite.

Modern tires are usually tubeless, as described above. The so-called inner liner is a radially inwardly disposed layer of a rubber compound and, to the largest extent possible, impermeable to air. It is also called the inner core or inner plate, and is used to ensure that the air pumped into the tire does not escape over a long period of time, as the air pressure significantly affects the driving characteristics and durability of the tire. In addition, the internal pressure also has an influence on the rolling resistance of the tire. A decrease in air pressure leads to a higher dynamic deformation of the tire which in turn causes the unwanted conversion of a part of the kinetic energy into thermal energy. This has a negative influence on the fuel consumption of the vehicle and thus on the associated emissions of carbon dioxide.

In addition, the inner liner protects the carcass against diffusion of air and humidity therein and prevents any damage to the strength-providing elements of the carcass and/or the belt. For the inner liner to remain airtight to the largest possible extent, it should also have good crack and fatigue resistance so that no cracks develop during driving which would affect the air tightness.

Due to this specific requirements profile, rubber compounds for inner liners have, with regard to the rubbers and fillers to be used as well as the weight proportions of the constituents relative to one another, completely different compositions than the rubber compounds for the other tire parts, but they still need to be compatible with the adjacent tire parts and especially need to have good adhesion to those. In addition to the type of rubbers, minimum quantities for different rubbers in the rubber compound also play a role, as do various specific parameters and properties of the fillers that can be used.

Among others, halobutyl rubbers such as chlorobutyl rubber or bromobutyl rubber, occasionally blended with other rubbers, are used as rubbers for the inner liner. Butyl and halobutyl rubbers have a low gas permeability. The blending of halobutyl rubbers with other rubbers such as for example natural rubber is carried out for reasons of increasing the tack during assembly, reducing costs and adjusting the mechanical properties.

By additional dosing of voluminous fillers with low or no activity to the rubber compound of the inner liners, their airtightness can be further increased. The fillers used to date include furnace carbon blacks in particular.

In order to prevent the formation of cracks under dynamic loads, inner liners must have a balanced modulus of elasticity and a matched hardness, which is usually in conflict with a high proportion of non-active fillers. Therefore, mineral oil-based softening agents are often added to the rubber composition, which reduce the modulus of elasticity and the hardness of the composition, but at the same time increase the gas permeability again, which results in a relatively narrow optimum range for the amounts of mineral oil-based softening agent and filler used.

In addition, many fillers, such as e. g. carbon blacks of the type N 660, have relatively high densities of about 1.8 g/cm³ or higher. Accordingly, the rubber compositions compounded with such fillers also have a higher density and thus a higher weight for the same volume. However, the higher density of the filler also causes a higher weight of the inner liner, and ultimately of the pneumatic tire, which in turn entails higher fuel consumption. Carbon blacks of types N 660 and N 772 in particular are used for inner liner production.

Industrial carbon blacks are usually produced petrochemically, by incomplete combustion or pyrolysis of hydrocarbons. The use of fossil energy sources for the production of fillers, however, must be avoided or reduced to a minimum from an environmental point of view. Instead, the objective should be to provide fillers for compounding that are based on biomass and that meet the manifold requirements for inner liners.

In the field of the preparation of rubber compositions for use in tires in general, among other things, WO 2017/085278 A1 discloses the use of so-called HTT lignin, a lignin converted by hydrothermal treatment, as a filler that substitutes for industrial carbon blacks.

Lignins are solid biopolymers that are incorporated into plant cell walls and thus effect the lignification of plant cells. They are therefore contained in biologically regrowing raw materials and—especially in their hydrothermally treated form—have potential as an environmentally friendly alternative to industrial carbon blacks in rubber compositions.

WO 2017/194346 A1 describes the use of HTT lignins in rubber compounds for pneumatic tire components, in particular together with a methylene donor compound such as e. g. hexa(methoxymethyl)melamine, in order to increase the stiffness of a cured rubber component of a pneumatic tire and, among other things, to replace phenolic resins, and/or in combination with silane-based coupling agents. One of the objects addressed in WO 2017/194346 is a decrease reduction of the rolling resistance of tires. Natural rubber, polybutadiene rubber, styrene-butadiene rubber and polyisoprene rubber are named as suitable rubber materials. WO 2017/194346 A1 discloses the suitability of the rubber compounds described therein for the tread areas of a pneumatic tire, for the sidewalls and the tire bead. A rubber compound that meets the requirements of an inner liner is not described in this document.

EP 3 470 457 A1 also discloses vulcanizable sulfur-containing rubber compounds for vehicle tires. The fillers used for the tested solvent-polymerized styrene-butadiene rubbers (SSBR) were HTT coals that were obtained from various feedstocks, were produced with the addition of metal halides and exhibited BET surface areas of up to more than 180 m²/g. Among these, HTT coals with a BET surface area of 90 to 140 m²/g were found to be particularly preferred, since they were said to exhibit enhanced surface roughness and optimized surface functionality.

WO 2020/202125 A1 teaches for the first time the use of a halobutyl rubber in combination with up to 45 phr (parts per hundred parts of rubber by weight) of a HTT lignin in the field of inner liner production, although this was never used as the sole filler in the examples of WO 2020/202125 A1, but is used exclusively in combination with a carbon black of type N 660. In particular, the aforementioned document teaches that the added carbon blacks must have a specific surface area of between 30 and 50 m²/g, which is a characteristic of carbon black of type N 600, which has a BET surface area of 35 m²/g (ASTM D 6556) and an STSA surface area of 34 m²/g (ASTM D 6556).

However, both the limitation of the HTT lignin content to a maximum of 45 phr and the limitation of the admixture of carbon blacks to carbon blacks with a maximum specific surface area of 50 m²/g have proved surprisingly disadvantageous with regard to the gas permeability to be reduced and the crack growth to be kept low, although the latter carbon blacks are those typically used in inner liners.

In a synoptic view of the state of the art, there is therefore a particular need for rubber compositions or rubber compounds which are suitable for inner liners of pneumatic tires, contain environmentally friendly material alternatives to carbon black that are based on regrowing raw materials as fillers, and provide vulcanized rubber compositions which satisfy the requirements for inner liners of pneumatic tires, in particular with regard to airtightness and crack resistance, and have an improved tear propagation resistance.

### SUMMARY OF THE INVENTION

The problems underlying the invention could be solved by providing a rubber composition that comprises
a rubber component, which
   comprises at least one halobutyl rubber selected from the group consisting of bromobutyl rubber and chlorobutyl rubber, and
a filler component which
   comprises one or more fillers F1 that
   have a ¹⁴C content in the range of 0.20 to 0.45 Bq/g of carbon;
   a carbon content in the range of 60 wt. % to 85 wt. % relative to the ash-free and water-free filler;
   have acidic hydroxy groups on its surface; wherein
   the weighted arithmetic average of the STSA surface areas of the fillers F1 is in the range from 40 m²/g to 80 m²/g;
   the fillers F1 have a volume-based median particle size distribution Dᵥ(50) in the range from 0.5 μm to 5 μm and a volume-based Dᵥ(97) value in the range from 3 μm to 23 μm;
   and
   i. the filler component comprises more than 45 phr of fillers F1; or
   ii. the filler component comprises more than 25 phr of fillers F1 and additionally comprises one or more industrial carbon blacks F2, wherein the weighted arithmetic average of the STSA surface areas of the industrial carbon blacks F2 is in the range of 55 m²/g to 95 m²/g;
wherein the amount of halobutyl rubber in the rubber composition is 60 to 100 phr.

The phr (parts per hundred parts of rubber by weight) specification used herein is the quantity specification commonly used in the rubber industry for compound formulations. The dosage of the parts by weight of the individual constituents is always based on 100 parts by weight of the total mass of all rubbers present in the compound.

This rubber composition will hereinafter also be referred to as the rubber composition according to the invention or the rubber composition according to the present invention.

The invention further relates to a vulcanizable rubber composition comprising or consisting of a rubber composition according to the invention and a vulcanization system containing zinc oxide and/or sulfur.

This vulcanizable rubber composition will hereinafter also be referred to as the vulcanizable rubber composition according to the invention or the vulcanizable rubber composition according to the present invention.

A further object of the invention is a kit of parts comprising, in spatially separated form, a rubber composition according to the invention and a vulcanization system containing zinc oxide and/or sulfur.

This kit of parts will hereinafter also be referred to as the kit of parts according to the invention or the kit of parts according to the present invention.

Another object of the present invention is a method for preparing a rubber composition according to the invention and a vulcanizable rubber composition according to the invention, the latter being obtained by preparing, in a first stage, the rubber composition according to the invention as a base compound (masterbatch) by compounding the constituents of the rubber composition and by performing, in a second stage, the admixture of the constituents of the vulcanization system.

These methods will also be referred to as methods according to the invention for preparing the rubber composition according to the invention or the vulcanizable rubber composition according to the invention.

Another object of the invention is a method for further processing of the vulcanizable rubber compositions according to the invention, in which they are formed into a web by calendering, extrusion or the so-called roller-head process.

This method will also be referred to as the method for further processing according to the invention or as the method for further processing according to the present invention.

Another object of the invention is a method for manufacturing a pneumatic tire, comprising the further processing method according to the invention, followed by a step of cutting to size the obtained web into an inner liner of pneumatic tires, and comprising the subsequent step of vulcanizing the inner liner thus obtained, preferably together with the carcass of a pneumatic tire.

The method will also be referred to as the method according to the invention for manufacturing a pneumatic tire or as the method according to the present invention for manufacturing a pneumatic tire.

Another object of the present invention is the use of the fillers F1 which are suitable within the context of the invention and as characterized above, as well as filler mixtures comprising F1 and F2 in rubber compositions for inner liners, wherein the fillers F1 and F2 are used in a total amount of at least 46 phr.

This use will also be referred to as the use according to the invention or as the use according to the present invention.

### DETAILED DESCRIPTION OF THE INVENTION

In the following, the constituents of the rubber compositions respectively used in the rubber compositions, the methods and the use cited above, as well as particularly suitable process sequences will be described in detail.

### Rubber Composition

### Rubbers

In the context of the present invention, one or more halobutyl rubbers selected from the group consisting of chlorobutyl rubbers (CIIR; chloro-isobutene-isoprene rubber) and bromobutyl rubbers (BIIR; bromo-isobutene-isoprene rubber) are used.

Halobutyl rubbers are halogenated isobutene-isoprene rubbers. They are obtainable by halogenation, especially bromination and/or chlorination of butyl rubbers.

Butyl rubbers, in turn, are predominantly composed of isobutene units, the remaining part being isoprene units. Particularly preferably the proportion of isobutene units is 95 to 99.5 mol % and the proportion of the isoprene units is 0.5 to 5 mol %, more particularly preferably, the proportion of isobutene units is 97 to 99.2 mol % and the proportion of the isoprene units is 0.8 to 3 mol %, wherein the proportion of isobutene units and isoprene units preferably add up to 100 mol % of the monomers contained in and polymerized into the polymer. Butyl rubbers generally have low gas and moisture permeability.

Due to the isoprene units polymerized into them, the butyl rubbers have carbon-carbon double bonds, which serve both for vulcanization and for the modification with halogens such as, in particular, chlorine and bromine.

The halobutyl rubbers obtainable by modification with halogens (halogenation) have a higher reactivity than the butyl rubbers and thus a broader spectrum in terms of vulcanization possibilities, such as in particular the co-vulcanization possibilities with other rubbers such as natural rubber (NR), butyl rubber (IIR; isobutene isoprene rubber) and styrene-butadiene rubber (SBR).

Among the halobutyl rubbers, the bromobutyl rubbers are more reactive due to their weaker carbon-bromide bond, as compared to the chlorobutyl rubbers that have a carbon-chlorine bond, which opens an even broader spectrum of vulcanization systems for bromobutyl rubbers. Bromobutyl rubbers vulcanize more rapidly and usually have better adhesion to diene rubbers.

Among the halobutyl rubbers, bromobutyl rubbers are particularly preferred in the context of the present invention.

It is however also possible to use compounds of one or more bromobutyl rubbers with one or more chlorobutyl rubbers as the halobutyl rubber component. Here, the bromobutyl rubbers increase the vulcanization rate.

Chlorobutyl rubbers (CIIR) suitable in the context of the present invention preferably contain between 1.1 and 1.3 wt. % of chlorine, the bromobutyl rubbers (BIIR) preferably contain between 1.9 to 2.1 wt. % of bromine. This corresponds to a proportion of reactive positions of about 2 mol %.

The viscosities of the halobutyl rubbers are preferably comprised between 35 and 55 Mooney units (ML (1+8), 125° C.). Just like butyl rubber, the products contain almost no secondary constituents (rubber proportion >98.5). The halobutyl rubbers preferably contain stabilizers, in particular sterically hindered phenols as stabilizers.

The rubber composition according to the invention can contain, in addition to the halobutyl rubbers, one or more further rubbers that differ from the halobutyl rubbers.

Particularly preferred as further rubbers that differ from the halobutyl rubbers are, if present, natural rubber, butyl rubber and styrene-butadiene rubber.

For example, the adhesion to other rubber-based tire components, in particular as compared to general-purpose rubbers, can thus be increased by admixture of natural rubber to halobutyl rubbers. By cross-linking the different rubbers, it is possible to create synergies with regard to tensile strength, so that it can lie even above the tensile strength of the individual rubbers. This is especially true with the use of vulcanization systems comprising zinc oxide, sulfur and a thiazole, such as e. g. mercaptobenzothiazole disulfide (MBTS). On the other hand, the gas and moisture permeability of the vulcanized end product typically increases with the admixture of natural rubber.

The admixture of styrene-butadiene rubbers to halobutyl rubbers can occur in the same way as the admixture of natural rubbers, but typically has no particular advantages over the latter, so that the use of natural rubbers, also with regard to the use of renewable resources, is usually preferred to that of the styrene-butadiene rubbers. As example, typical natural rubbers are available under the names SMR (“Standard Malaysian Rubber”), TSR (“Technically Specified Rubber”) and RSS (“Ribbed Smoked Sheets”).

The admixture of up to 30 phr, preferably up to at most 20 phr butyl rubber to halobutyl rubber has typically only minor to no effect on the gas and moisture permeability of the vulcanized end products, but it can decrease the vulcanization rate and increase the heat resistance, where this is desired.

The total amount of halobutyl rubber is 60 to 100 phr, preferably 65 to 100 phr, particularly preferably 70 to 100 phr, further preferably 75 or 80 to 100 phr, more particularly preferably 85 or 90 to 100 phr, like 95 to 100 phr, and most preferably 100 phr.

In the case that the rubber compound contains less than 100 phr halobutyl rubber, at least one other rubber is contained in the rubber composition, preferably one of the rubbers mentioned above, more particularly preferably natural rubber, so that the total amount of rubbers contained is 100 phr.

This means that the amount of other rubbers that differ from the halobutyl rubbers is from 0 to 40 phr, preferably from 0 to 35 phr, particularly preferably from 0 to 30 phr, further preferably from 0 to 20 or 25 phr and more particularly preferably from 0 to 10 or 15 phr, as example 0 to 5 phr or 0 phr.

### Fillers F1

Obligatorily used in the filler component is one or more fillers F1 that have a ¹⁴C content in the range of 0.20 to 0.45 Bq/g carbon, preferably 0.23 to 0.42 Bq/g carbon;
have a carbon content in the range of 60 wt. % to 85 wt. %, preferably 63 wt. % to 80 wt. %, and particularly preferably 65 wt. % to 75 wt. %, and more particularly preferably 68 wt. % to 73 wt. %, relative to the ash-free and water-free filler;
wherein the weighted arithmetic average of the STSA surface areas of the fillers F1 is in the range from 40 m²/g to 80 m²/g, preferably from 42 m²/g to 75 m²/g, more preferably from 44 m²/g to 70 m²/g;
the one or more fillers F1 have a volume-based median particle size distribution Dᵥ(50) in the range from 0.5 μm to 5 μm, particularly preferably 1 μm to 4 μm, more particularly preferably 1 μm to 3 μm, and a volume-based Dᵥ(97) value in the range from 3 μm to 23 μm, preferably of at most 18 μm, particularly preferably of at most 15 μm, more particularly preferably of at most 12 μm, even more preferably of at most 10 μm, even more preferably of at most 9 μm, even more preferably of at most 8 μm, most preferably of at most 7 μm, more particularly preferably of at most 6 μm;
and the one or more fillers F1 have acidic hydroxy groups on their surfaces.

The required ¹⁴C content cited above is achieved by fillers F1 obtained from biomass, by further treatment or reaction, preferably by decomposition, wherein the decomposition can be carried out thermally, chemically and/or biologically, and preferably is carried out thermally and chemically. Thus, filler obtained from fossil materials, such as fossil fuels in particular, do not fall under the definition according to the present invention of the fillers to be used according to the invention, since they do not possess a corresponding ¹⁴C content.

Herein, biomass is in principle defined as any biomass, wherein the term “biomass” herein includes so-called phytomass, i.e., biomass originating from plants, zoomass, i.e., biomass originating from animals, and microbial biomass, i.e., biomass originating from microorganisms including fungi, wherein the biomass is dry biomass or fresh biomass, and it originates from dead or living organisms.

The biomass particularly preferred herein for the preparation of the fillers F1 is phytomass, preferably dead phytomass. Dead phytomass comprises, among other things, dead, rejected or detached plants and their parts. These include, for example, broken and torn leaves, side shoots, twigs and branches, the fallen leaves, felled or pruned trees, as well as seeds and fruits and parts derived therefrom, but also sawdust, wood shavings/chips and other products derived from wood processing.

The carbon content cited above is typically achieved by the fillers based on the decomposition of biomass and can be determined by elemental analysis according to DIN 51732:2014-7.

Preferably, the fillers F1 have an oxygen content in the range of 15 wt. % to 30 wt. %, preferably 17 wt. % to 28 wt. % and particularly preferably 20 wt. % to 25 wt. %, relative to the ash-free and water-free filler. The oxygen content is defined herein as the difference to the carbon, hydrogen, nitrogen and sulfur content.

In addition, the fillers F1 of the type defined above have acidic hydroxy groups on their surface (so-called surface-available acidic hydroxy groups). The determination of the surface-available acidic hydroxy groups can be carried out qualitatively and quantitatively by colorimetry according to Sipponen. The method according to Sipponen is based on the adsorption of the alkaline dye Azure B onto the acidic hydroxy groups accessible on the filler surface. If there is a corresponding adsorption under the conditions cited in the article mentioned below under item 2.9 (p. 82), acidic, surface-available hydroxy groups in the sense of the present invention are present. Further details can be taken from the paper “Determination of surface-accessible acidic hydroxyls and surface area of lignin by cation dye adsorption” (Bioresource Technology 169 (2014) 80-87). In a quantitative determination, the amount of surface-available acidic hydroxy groups is given in mmol/g of the filler. Preferably, the amount of surface-available acidic hydroxy groups is in the range of 0.05 mmol/g to 40 mmol/g, particularly preferably 0.1 mmol/g to 30 mmol/g, and more particularly preferably 0.15 to 30 mmol/g. Preferred surface-available acidic hydroxy groups are phenolic hydroxy groups.

Clear differences between the biomass-based fillers also exist in their BET surfaces (specific total surface area according to Brunauer, Emmett and Teller) as well as their external surfaces (STSA surface area; Statistical Thickness Surface Area).

For example, WO 2017/085278 A1 describes STSA surface areas in the range of 5 to 200 m²/g for hydrothermally treated lignins, i.e., fillers based on dead phytomass containing lignin that is obtained by hydrothermal treatment. In the experimental part of the publication, even those with an STSA surface area of only 2.6 m²/g are mentioned.

In the context of the invention, the term weighted arithmetic average of the STSA surfaces of the fillers is also mentioned in particular. The term “weighted arithmetic average” is used in the context of the present invention in its usual meaning.

In connection with the STSA surface area in relation to the filler F1, when only one filler F1 is used, the weighted arithmetic average of the STSA surface area of this filler therefore corresponds exactly to the STSA surface area of this filler F1, since its relative frequency is 1 (weighted arithmetic average of the STSA surface area=[STSA surface area of F1]×1). When using a mixture of, for example, two different fillers F1′ and F1″, in which, for example, 70% by weight of filler F1′ (corresponds to a relative frequency of 0.7) and 30% by weight of filler F1″ (corresponds to a relative frequency of 0.3) are present, the weighted arithmetic average of the STSA surface areas of the fillers F1=([STSA surface area of F1′]×0.7)+ ([STSA surface area of F1″]×0.3) or in general:
weighted arithm. average of the STSA surface areas of the fillers F1=Σ(STSA_{F1i}×hᵢ), wherein STSA_{F1i} stands for the STSA surface area of the filler F1ᵢ and hᵢ for the relative amount of this filler.

Preferably, the STSA surface areas of each individual filler F1 are also in the range from 40 to 80 m²/g, particularly preferably in the range from 40 to 75 m²/g, more particularly preferably in the range from 42 to 70 m²/g. The selection of the individual fillers F1 is, of course, based on the mandatory requirement that the weighted arithmetic average of the STSA surface areas of the fillers F1 is in the range from 40 m²/g to 80 m²/g, preferably 42 m²/g to 75 m²/g, particularly preferably 44 m²/g to 70 m²/g.

The fillers F1 have a volume-based median of the particle size distribution Dᵥ(50) of a minimum of 0.5 μm and a maximum of 5 μm and a volume-based Dᵥ(97) value of the particle size distribution of a minimum of 3 μm and a maximum of 23 μm. The volume-based median of the particle size distribution Dᵥ(50) is in the range from 0.5 to 5 μm, particularly preferably in the range from 1 to 4 μm and more particularly preferably in the range from 1 to 3 μm. The volume-based Dᵥ(97) value of the particle size distribution is in the range from 3 μm to 23 μm, preferably up to a maximum of 18 μm, particularly preferably up to a maximum of 15 μm, more particularly preferably up to a maximum of 12 μm, even more preferably up to a maximum of 10 μm, even more preferably up to a maximum of 9 μm, even more preferably up to a maximum of 8 μm, most preferably up to a maximum of 7 μm, more particularly preferably up to a maximum of 6 μm. The particle size distribution and the Dᵥ(50) or Dᵥ(97) values are determined by means of laser diffraction as described in detail in the experimental part. The Dᵥ(97) value of a filler F1 is naturally always greater than the Dᵥ(50) value of the same filler F1.

The particle size distribution is not an inherent property of the fillers F1 that results directly from their production. Rather, the biomass-based fillers are deagglomerated by crushing processes such as milling to such an extent that the particle size distributions according to the invention result. Excessively large particle sizes of filler particles exhibit lower reinforcement, which is reflected in a flat tensile strain curve and thus lower tensile strength. Particle sizes that are too small make dispersion in the polymer matrix more difficult and the filler particles are then present as insufficiently dispersed clusters.

All the above ranges characterizing fillers F1 in terms of their ¹⁴C content, carbon and oxygen content, STSA surface area and surface-available acid groups as well as particle size distribution apply equally to all fillers F1 to be used according to the invention, but preferably to lignin-based fillers, which herein represent a preferred class of fillers that can be produced from phytomass.

In their textbook “Kautschuk Technologie—Werkstoffe Verarbeitung Produkte” (3rd revised and expanded edition, 2013, pages 1196-1197), Röthemeyer and Sommer classify various rubbers into three groups, those with low polarity and high degree of swelling in oil, those with medium polarity and medium degree of swelling in oil, and those with high polarity and low degree of swelling in oil. Despite their reactivity, halobutyl rubbers have low polarity.

Particularly surprising, therefore, is the good compatibility of the fillers F1 to be used according to the invention, in particular of the lignin-based fillers, with the halobutyl rubbers, which have only a low polarity, since the fillers to be used according to the invention have a high polarity compared to the typical industrial carbon blacks, which is due, among other things, to the content of surface-available acidic hydroxy groups. But also the higher oxygen content compared to the industrial carbon blacks contributes to this.

Among the lignin-based fillers F1, lignin-containing phytomass that is hydrothermally treated is particularly preferred. Preferred treatment is a hydrothermal treatment at temperatures between 150° C. and 250° C. in the presence of liquid water. Compared to the original lignin, the carbon content usually increases and the oxygen content decreases. Suitable methods for treatment are for example described in WO 2017/085278 A1. Lignin-based fillers obtained by hydrothermal treatment will hereinafter also be referred to as HTT lignins (“hydrothermally treated lignins). The term HTC lignin (“hydrothermally carbonized lignin”) is also frequently used in the literature. Fillers referred as HTC lignins also fall under the term HTT lignins. A hydrothermal treatment at temperatures between 150° C. and 250° C. in the presence of liquid water will also be referred to as hydrothermal treatment in the following. The HTT lignins described in the following are the preferred fillers F1 to be used in the context of the present invention.

In one embodiment, the rubber composition according to the invention comprises more than 45 phr, preferably at least 46 phr, particularly preferably 48 to 80 phr, more particularly preferably 50 to 75 phr, especially 50 to 70 phr of the above defined filler F1 to be used according to the invention.

In a further embodiment, the rubber composition according to the invention comprises more than 35 phr, preferably at least 36 phr, particularly preferably 38 to 80 phr, more particularly preferably 40 to 70 phr, especially 50 to 65 phr of the filler F1 to be used according to the invention as defined above in combination with one or more industrial carbon blacks F2, wherein the weighted arithmetic average of the STSA surface areas of the industrial carbon blacks F2 are in the range from 55 m²/g to 95 m²/g. In this embodiment, it is preferred that the sum of the fillers F1 and industrial carbon blacks F2 in the filler component is at least 40 phr, particularly preferably at least 43 phr to 80 phr, more particularly preferably 46 to 70 phr, especially 48 to 65 phr.

### HTT Lignins

HTT lignins are obtained by hydrothermal treatment of lignin-containing raw materials and represent particularly preferred fillers F1 usable according to the invention. The properties of HTT lignins can vary over wide ranges. For example, different HTT lignins differ in their BET and STSA surface area, the ash content, pH, and heat loss, as well as the density and particle size and the amount of surface-available acidic hydroxy groups and particle size distributions.

In the context of the present invention, special HTT lignins, as fillers F1 to be used according to the invention, serve as a substitute material for the carbon blacks usually contained in rubber compositions for inner liners. The preparation of the HTT lignins usable according to the invention is described in WO 2017/085278 A1 for example. The accordingly produced fillers F1 are crushed, in particular milled, until the required particle size distribution is achieved.

While the above-mentioned documents WO 2017/085278 A1 and WO 2017/194346 A1 generally mention the use of HTT lignins as possible substitute materials for carbon blacks in tires, it should not be concluded that the behavior of HTT lignins in ordinary rubber compositions would readily be transferable to the special rubber compositions of the present invention, which contain more reactive halobutyl rubbers. This is especially true for their use in rubber compositions based on halobutyl rubbers, since these have completely different properties from ordinary rubber compositions and, due to the high reactivity of the halogen atoms, in particular the chlorine and especially the bromine atoms, an interaction or even reaction with the fillers that can be used according to the invention, in particular the HTT lignins, has to be expected, which have, as compared to industrial carbon blacks, a chemically different surface and composition. In particular, the difference already mentioned above between industrial carbon blacks and the fillers to be used in the present invention in terms of the presence of surface-available acidic hydroxy groups, preferably phenolic hydroxyl groups, leads to surprisingly good incorporability of the fillers and compatibility of the same with the rubber component, even without the use of compatibilizers, in particular without the use of silane compounds in the rubber compositions according to the invention. The resulting vulcanized products have surprisingly good performance, wherein even critical properties, such as the extremely low gas permeability required for inner liners, are improved.

It was also surprising that, contrary to the teaching of WO 2020/202125 A1, significantly higher quantities of fillers F1 with STSA surfaces in the upper range can be used and, in particular, combinations with industrial carbon blacks with high STSA surface areas of at least 55 m²/g achieve excellent results.

To achieve the advantages, a purposeful selection of special fillers F1 was required for the present invention. Among these, HTT lignins have proven to be particularly suitable, as they have both excellent compatibility with the other constituents of the rubber composition, and also compatibility with the special vulcanization systems described below, and in particular enable the desired gas barrier properties and reduce the formation of cracks and crack growth.

The fillers F1 to be used according to the invention, and in particular the HTT lignins, which are used in the present invention, allow for adjustment of a good balance of different properties with regard to their use in inner liners. Thus, they have good reinforcing properties, expressed by stress values and tear strength of the vulcanized rubber, high elongation at break of the rubber, and they also facilitate good dispersibility of the filler particles in the rubber. In particular, their use, especially in higher quantities, leads to a significantly reduced gas permeability and reduced crack growth of the vulcanized rubbers.

To achieve this, it is advantageous that the fillers F1 used in the context of the invention, preferably the HTT lignins have—in addition to the STSA surface areas indicated above—also BET surface areas in the range of 40 to 100 m²/g, preferably of 42 to 75 m²/g and particularly preferably of 44 to 70 m²/g.

Preferably, the fillers F1 used according to the invention, preferably the HTT lignins, have a pH in the range from 7 to 10, particularly preferably in the range from 8 to 9.5.

It was also found that ash content and heat loss have only a minor influence, as long as the values are not too high and thus reduce the content of active ingredients too much.

The fillers used herein, preferably the HTT lignins, have the potential—as shown in the experimental part of the present application—to completely replace carbon blacks in the production of rubber compositions, in particular those for the production of inner liners, although the fillers F1 used herein have a significantly higher STSA surface area than the industrial carbon blacks N660 and N772 commonly used in inner liners. This means that preferred rubber compositions according to the invention do not need to contain carbon blacks from materials of fossil origin.

This makes it possible, among other things, to produce inner liners for pneumatic tires which have significantly lower weight, improved air holding capacity and improved crack resistance with reduced crack growth, with the same dimensions of comparable inner liners obtained using carbon blacks. Especially the better air holding capacity makes sure that the rolling resistance of the tire is at the optimum level over a long period of time and therefore allows a more economical operation of the vehicle equipped with the tires.

It is also possible, however, to replace only a part of the carbon blacks from materials of fossil origin with one or more of the fillers F1 usable according to the invention, preferably the HTT lignins. The F2 carbon blacks described below are particularly advantageous for this purpose, even though in particular their STSA surfaces far exceed the specifications of the carbon blacks normally used in inner liners. This also introduces a new field of application for the industrial carbon blacks F2.

### Other Constituents of the Rubber Composition

### Fillers F2 (=Industrial Carbon Blacks F2)

In addition to the above-mentioned and mandatory fillers F1 to be used according to the invention F1, preferably HTT lignins F1, the rubber compositions may contain in the filler component further fillers F2 which are different from F1, namely industrial carbon blacks with the above-mentioned specifications.

For the calculation of the weighted arithmetic mean of the STSA surfaces of the industrial carbon blacks F2, the same as said for the fillers F1 applies.

The weighted arithmetic average of the STSA surface areas of the industrial carbon blacks F2 is in the range from 55 m²/g to 95 m²/g, preferably in the range from 60 m²/g to 92 m²/g, particularly preferably in the range from 65 m²/g to 91 m²/g and more particularly in the range from 70 m²/g to 85 m²/g, especially 72 m²/g to 80 m²/g.

Preferably, the STSA surface area of each individual industrial carbon black F2 (i.e. filler F2) is also in the range from 55 to 95 m²/g, particularly preferably in the range from 65 to 90 m²/g, more particularly preferably in the range from 70 to 85 m²/g. The selection of the individual fillers F2 is, of course, based on the mandatory requirement that the weighted arithmetic average of the STSA surface areas of the fillers F2 lies within the ranges mentioned in the preceding paragraph.

Surprisingly, it has been found that the use of the industrial carbon blacks F2 characterized as above leads to advantages in terms of higher tensile strength and, in particular, higher elongation at break. In particular, the small aggregate size appears to have a positive effect on crack growth, as presumably more particles and thus more imperfections in the same unit volume counteract crack growth.

Compared to the partial replacement of the fillers F1 by the carbon blacks N660 and N772 used in inner liner production, which have an STSA surface area of 34 m²/g and 28 m²/g, the industrial carbon blacks F2 characterized as above allow to provide STSA surface areas in the range from 55 to 95 m²/g, particularly preferably in the range from 65 to 90 m²/g, more particularly preferably in the range from 70 to 85 m²/g.

For example, the carbon black N326 contains smaller aggregates compared to the semi-active carbon blacks N660 and N772 due to the higher specific surface area (STSA). The inventors of the present invention assume that there are more particles in the unit volume at the same dosage, and that this improves the physical interaction and produces a higher reinforcement. This appears to be particularly advantageous in terms of dynamic crack resistance.

Preferred industrial carbon blacks F2 are those that are listed in the ASTM D1765 standard and have the designation N3XX. These include, in particular, industrial carbon blacks with the designations N326, N330, N347, N339, N375 and N351.

The fillers F2 are never used alone, but always at least in combination with the fillers F1 in the filler component. When fillers F2 are used, however, the amount of fillers F1 is more than 35 phr, preferably at least 36 phr, particularly preferably at least 38 phr, such as at least 40 phr.

In case that further fillers F2 with the above characteristics are used, their content is preferably less than 25 phr, more preferably 1 to 25 phr, more preferably 5 to 20 phr, and more particularly preferably 8 to 18 phr.

Preferably, the sum of the amounts of fillers F1 and industrial carbon blacks F2 is at least 45 phr, more preferably 45 to 80 phr, more particularly preferably 45 to 70 phr, and even more preferably 45 to 60 phr.

The content of fillers F1 in the sum of all fillers F1 plus F2 is preferably 50 to 100% by weight, more preferably 65 to 100% by weight and more particularly preferably 80 to 100% by weight.

The weighted arithmetic average of the STSA surface areas of the sum of the fillers F1 and industrial carbon blacks F2 is at least 40 m²/g, particularly preferably 45 m²/g to 65 m²/g, more particularly preferably 47 m²/g to 63 m²/g and even more preferably 50 m²/g to 60 m²/g.

### Fillers F3

The rubber composition of the present invention may comprise, in addition to the fillers F1 and optionally present fillers/industrial carbon blacks F2, further fillers F3 which do not fall within the definitions of fillers F1 and F2. These are in particular inorganic fillers of different particle size, particle surface area and chemical nature, with varying potential to influence the vulcanization behavior. In the event that further fillers are included, these should preferably have properties as similar as possible to the fillers F1 and F2 used in the rubber composition according to the invention.

If other fillers F3 are used, they are preferably phyllosilicates such as clay minerals, for example talc; carbonates such as calcium carbonate; and silicates such as for example calcium, magnesium, and aluminum silicates. However, they can also be fillers F3, which each have an STSA surface area of less than 40 m²/g or greater than 80 m²/g and moreover meet the specifications of the fillers F1 with regard to the ¹⁴C content and carbon content, preferably also meet the specifications with regard to the particle size distribution and the acidic hydroxy groups. However, the fillers F3 can also be industrial carbon blacks F3, which have an STSA surface area of less than 55 m²/g or greater than 95 m²/g.

Inorganic fillers, among them preferably silica and other fillers, which carry Si—OH groups on their surface, may also be surface-treated. In particular, a salinization with organosilanes, such as for example alkylalkoxysilanes or aminoalkylalkoxysilanes or mercaptoalkylalkoxysilanes, may be of advantage. The alkoxysilane groups can, for example, bind to the surfaces of silicates or silica, or to other suitable groups, by hydrolytic condensation, while the amino groups and thiol groups, for example, can react with the halogenated, in particular brominated, isoprene units of the halobutyl rubbers. This can cause a mechanical reinforcement of the vulcanized rubber compositions of the present invention.

The utilization of salinized fillers can lead to an acceleration in achieving the final vulcanization state and increase the edge tearing resistance.

The fillers can be used individually or in combination.

Preferably, no or only low amounts of fillers F3 are used in addition to the fillers F1, in particular the HTT lignins F1, and any further fillers F2 optionally present therein used according to the invention. If further fillers F3 are used, these are preferably industrial carbon blacks F3, which do not fall under the definition of industrial carbon blacks F2, or phyllosilicates such as clay minerals, and for example talc. The content of fillers F3 in the filler component is preferably less than 40 phr, particularly preferably 0 to 25 phr, more particularly preferably 0 to 15 phr.

### Softening Agents

With the use of softening agents, it is possible to influence properties of the unvulcanized rubber composition, such as processability in particular, but also properties of the vulcanized rubber composition, such as its flexibility, especially at low temperatures.

Particularly suitable softening agents in the context of the present invention are mineral oils from the group of paraffinic oils (substantially saturated chain-shaped hydrocarbons) and naphthenic oils (substantially saturated ring-shaped hydrocarbons). The use of aromatic hydrocarbon oils is possible, but less advantageous, as they show poorer dissolution behavior with halobutyl rubbers. However, with regard to the adhesion of the rubber composition to other rubber-containing components in tires, such as for example the carcass, a mixture of paraffinic and/or naphthenic oils could be advantageous as softening agent.

Other softening agents are for example esters of aliphatic dicarboxylic acids, such as for example adipic acid or sebacic acid, paraffin waxes and polyethylene waxes.

Among the softening agents, paraffinic oils and naphthenic oils are particularly suitable in the context of the present invention.

Preferably, the softening agents, and among them more particularly preferably the paraffinic and/or naphthenic oils, are used in an amount of 0 to 20 phr, preferably 5 to 15 phr, particularly preferably 7 to 13 phr.

### Adhesion-Enhancing Resins (“Tackifying Resins”)

So-called adhesion-enhancing resins can be used to improve the adhesion of the vulcanized rubber compound of the present invention to other adjacent tire components.

Particularly suitable resins are those based on phenol, preferably from the group consisting of phenolic resins, phenol-formaldehyde resins and phenol-acetylene resins.

In addition to the resins based on phenol, aliphatic hydrocarbon resins such as Escorez™ 1102 RM from ExxonMobil, as well as aromatic hydrocarbon resins, may also be used. Aliphatic hydrocarbon resins particularly improve adhesion to other rubber components of the tire. They generally have lower adhesion than the resins based on phenol and can be used either alone or as a mixture with the resins based on phenol.

If the adhesion-enhancing resins are used at all, then preferably those selected from the group consisting of resins based on phenol, aromatic hydrocarbon resins and aliphatic hydrocarbon resins. Preferably, their amount is 0 to 15 phr or 1 to 15 phr, particularly preferably 2 to 10 phr and more particularly preferably 3 to 8 phr.

### Additives Promoting Vulcanization

The rubber composition according to the invention may also contain additives that promote vulcanization, but are unable to start it on their own. Such additives include, for example, vulcanization accelerators such as saturated fatty acids with 12 to 24, preferably 14 to 20 and particularly preferably 16 to 18 carbon atoms, such as stearic acid and the zinc salts of the aforementioned fatty acids. Thiazoles may also belong to these additives. However, it is also possible to use vulcanization-promoting additives only in the vulcanization systems described below.

If vulcanization-promoting additives and in particular the above-mentioned fatty acids and/or their zinc salts, preferably stearic acid and/or zinc stearate, are used in the rubber compositions according to the invention, their amount is preferably 0 to 5 phr, particularly preferably 0.5 to 3 phr and particularly preferably 1 to 2 phr.

Preferably, the rubber composition according to the invention thus contains, in addition to the obligatory constituents, one or more constituents selected from the group consisting of
i. rubbers that differ from halobutyl rubbers,
ii. Industrial carbon blacks F1 and/or fillers F3,
iii. softening agents,
iv. adhesion-enhancing resins, and
v. additives promoting vulcanization,

If one or more of the constituents mentioned under items i. to v. above are included, then
i. preferably is a rubber selected from the group consisting of natural rubber, butyl rubber and styrene-butadiene rubber,
ii. is a filler F2 as defined above or a filler F3 selected from the group of carbon blacks different from F2 and the phyllosilicates,
iii. preferably is an ester of an aliphatic dicarboxylic acid, a paraffinic oil and/or a naphthenic oil,
iv. is a resin selected from the group of aliphatic hydrocarbon resins, aromatic hydrocarbon resins, phenolic resins, phenol-formaldehyde resins and phenol-acetylene resins; and
v. is an additive selected from the group of saturated fatty acids having 12 to 24 carbon atoms and of the thiazoles.

If the components i. to v. are included, then they are preferably included in the following amounts:
i.0 to 40 phr, particularly preferably 0 to 30 phr, more particularly preferably 0 to 20 phr or 0 phr;
ii.0 to 40 phr, more preferably 0 to 25 phr, particularly preferably 0.1 to 20 phr, more particularly preferably 0.5 to 18 phr;
iii.0 to 20 phr, particularly preferably 5 to 15 phr, more particularly preferably 7 to 13 phr;
iv.0 to 15 phr, particularly preferably 2 to 10 phr, more particularly preferably 3 to 8 phr; and
v.0 to 5 phr, particularly preferably 0.5 to 3 phr, more particularly preferably 1 to 2 phr.

### Vulcanizable Rubber Composition

The vulcanizable rubber compositions of the present invention comprise a rubber composition according to the invention and a vulcanization system serving for its vulcanization.

### Vulcanization Systems

The vulcanization systems are not included herein among the rubber compositions of the invention, but are treated as additional systems that condition their crosslinking. By addition of the vulcanization systems to the rubber compositions according to the invention, the vulcanizable rubber compositions also according to the invention are obtained.

The rubber compositions of the present invention based on halobutyl rubbers allow for the use of a wide variety of different vulcanization systems. The chlorine-carbon bond that is weaker in comparison to a carbon-carbon bond, but especially the bromine-carbon bond, allows faster vulcanization as well as better co-vulcanization with general-purpose rubbers.

The vulcanization of the rubber compositions of the present invention is preferably carried out using zinc oxide and/or sulfur.

In the preferred variants described hereinafter, zinc oxide is preferably used in combination with different organic compounds for vulcanization. By means of the different additives, the vulcanization behavior as well as the properties of the vulcanized rubbers thus obtained may be influenced.

In a first variant of the zinc oxide-based vulcanization, small amounts of a saturated fatty acid with 12 to 24, preferably 14 to 20 and particularly preferably 16 to 18 carbon atoms, for example stearic acid and/or zinc stearate, are preferably added to the zinc oxide as a vulcanization accelerator. This allows to increase the vulcanization rate. Most often, however, the final grade of vulcanization is reduced with the use of the fatty acids mentioned.

In a second variant of the zinc oxide-based vulcanization, so-called thiurams such as thiuram monosulfide and thiuram disulfide and/or dithiocarbamates are added to the zinc oxide, in the absence of sulfur, in order to shorten the scorch time and to improve the vulcanization efficiency by forming particularly stable networks.

In a third variant of the zinc oxide-based vulcanization, an alkylphenol disulfide is added to the zinc oxide to adapt the scorch times, in particular to accelerate them.

Another, i.e., fourth, variant of the zinc oxide-based vulcanization employs a combination of zinc oxide with polymethylolphenol resins and their halogenated derivatives, wherein neither sulfur nor sulfur-containing compounds are used.

In a further, fifth variant of the zinc oxide-based vulcanization, the vulcanization is carried out by means of a combination of zinc oxide with thiazoles and/or sulfenamides and preferably sulfur. The thiazoles and sulfenamides are preferably selected from the group consisting of 2-mercaptobenzothiazole (MBT), mercaptobenzothiazyl disulfide (MBTS), N-cyclohexyl-2-benzothiazyl sulfenamide (CBS), 2-morpholino-thiobenzothiazole (MBS) and N-tert-butyl-2-benzothiazyl sulfenamide (TBBS). The addition of sulfur to such systems increases both the vulcanization rate and the extent of vulcanization and contributes to the workability of the rubber compositions during the vulcanization process. The co-vulcanization with rubbers that differ from the halobutyl rubbers, especially those mentioned above, is also favored. The use of this vulcanization system preferably provides heat- and fatigue-resistant vulcanized materials that exhibit good adhesion to other components of vehicle tires, especially to rubber compositions of the carcass, even in the vulcanized state. A particularly advantageous vulcanization system comprises zinc oxide, a thiazole such as preferably mercaptobenzothiazyl disulfide (MBTS), and sulfur. Particularly preferred is the combination of the first variant with the fifth variant, i. e., employing a vulcanization system comprising zinc oxide, a thiazole such as preferably mercaptobenzothiazyl disulfide (MBTS), sulfur as well as stearic acid and/or optionally zinc stearate.

Less preferred vulcanization systems are based on a pure sulfur vulcanization or a peroxide vulcanization, wherein the latter can lead to an undesirable reduction in molecular weights due to cleavage of the molecules, especially when butyl rubber or other rubbers are also used.

In the context of the present invention, the vulcanization of the rubber composition according to the invention is carried out in the presence of the specific fillers F1, preferably the specific HTT lignins and optionally the industrial carbon blacks F2. The excellent properties of the vulcanized rubber composition according to the invention, in particular its suitability as an inner liner, are substantially based on the combination of the suitable rubber component with the specific fillers F1, in particular the preferred HTT lignins F1 and optionally F2 in the specified amounts, and a zinc oxide-based vulcanization system, preferably a vulcanization system of the variant referred to above as the fifth variant, even more preferably the combination of the first variant with the fifth variant.

Components of the vulcanization systems, which as such cannot initiate vulcanization, may also be contained in the rubber composition of the present invention as “other constituents of the rubber composition”. Thus, it is possible that in particular the stearic acid and/or optionally zinc stearate and/or the thiazole compound are already present in the rubber composition and the complete vulcanization system is formed in situ by adding zinc oxide and sulfur.

### Kit of Parts

Due to the relationship between the rubber compositions according to the invention and the crosslinking systems to be selected for their vulcanization, the present invention also relates to a kit of parts comprising the rubber composition according to the invention and a vulcanization system, preferably a zinc oxide and/or sulfur-based vulcanization system. In the kit of parts, the rubber composition according to the invention and the vulcanization system are spatially separated from one another and can thus be stored. The kit of parts serves for the preparation of the vulcanizable rubber composition. For example, the rubber composition according to the invention constituting one part of the kit of parts can be used as part (A) in step 1 of the method described below for preparing a vulcanizable rubber compound, and the second part of the kit of parts, i.e., the vulcanization system, can be used as part (B) in step 2 of said method.

Preferably, the kit of parts comprises, as
part (A), a rubber composition according to the present invention, and as
part (B), a vulcanization system comprising zinc oxide and/or sulfur.

Particularly preferably, the kit of parts comprises, as
part (A), a rubber composition according to the present invention, and as
part (B), a vulcanization system comprising zinc oxide, sulfur, and a thiazole; or as part (A), a rubber composition according to the present invention containing a thiazole, and as
part (B), a vulcanization system comprising zinc oxide and/or sulfur.

More particularly preferably, the kit of parts comprises, as
part (A), a rubber composition according to the present invention, and as
part (B), a vulcanization system comprising zinc oxide, sulfur, a thiazole and stearic acid and optionally zinc stearate; or as
part (A), a rubber composition according to the present invention, containing stearic acid and optionally zinc stearate, and as
part (B), a vulcanization system comprising zinc oxide, sulfur and a thiazole.

The preferred thiazole in the above kits of parts is MBTS.

In contrast to the vulcanizable rubber composition that already contains both the constituents of the rubber composition according to the invention and those of the associated vulcanization system in a homogenous mixture, so that the vulcanizable rubber composition can be vulcanized directly, the rubber composition according to the invention and the vulcanization system are spatially separated in the kit of parts.

The vulcanizable rubber composition obtainable from the kit of parts will herein also be referred to as “green compound”. It can be obtained by the two-stage method described in the following section.

### Method for Preparing the Rubber Composition According to the Invention and a Vulcanizable Rubber Composition Therefrom

The preparation of the vulcanizable rubber compound is preferably carried out in two stages.

In the first stage, the rubber composition according to the invention is first prepared as a base compound (masterbatch) by compounding the constituents of the rubber composition. In the second stage, the constituents of the vulcanization system are admixed.

### Stage 1

Preferably, the halobutyl rubbers and any additional rubbers optionally used, as well as any adhesion-enhancing resin optionally used, are provided. However, the latter can also be added together with the other additives. Preferably, the rubbers have at least room temperature (23° C.) or are used after preheating to temperatures of not more than 50° C., preferably not more than 45° C., and particularly preferably not more than 40° C. Particularly preferably, the rubbers are pre-masticated for a short period of time before the other constituents are added. If inhibitors such as magnesium oxide are used for subsequent vulcanization control, they are preferably also added at this point of time.

Subsequently, the fillers F1 to be used according to the invention, preferably as HTT lignins, and optionally other fillers F2 and/or F3 are added, preferably with the exception of zinc oxide, since this is used as a constituent of the vulcanization system in the rubber compositions according to the invention and is therefore herein not considered as a filler. The addition of the fillers F1 to be used according to the invention, preferably the HTT lignins and optionally other fillers F2 and/or F3, is preferably carried out incrementally.

Advantageously, but not necessarily, softening agents and other constituents such as stearic acid and/or zinc stearate are added only after the addition of the fillers F1 to be used according to the invention, preferably HTT lignins, or the other fillers F2 and/or F3, if used. This facilitates the incorporation of the fillers F1 to be used according to the invention, preferably HTT lignins and, if present, the other fillers F2 and/or F3. It may be advantageous, however, to incorporate a part of the fillers F1 to be used according to the invention, preferably HTT lignins or, if present, the other fillers F2 and/or F3, together with the softening agents and any other constituents optionally used.

The highest temperatures obtained during the preparation of the rubber composition in the first stage (“dump temperature”) should not exceed 140° C., since there is a risk of partial decomposition of the reactive halobutyl rubbers above these temperatures. Preferably, the maximum temperature during the preparation of the rubber composition of the first stage is between 100° C. and 130° C., particularly preferably between 105° C. and 120° C.

The mixing of the constituents of the rubber composition according to the invention is usually carried out by means of internal mixers equipped with tangential or meshing (i.e., intermeshing) rotors. The latter usually allow for better temperature control. However, mixing can also be carried out using a double-roll mixer, for example.

After the preparation of the rubber composition, it is preferably cooled down before carrying out the second stage. A process of this type is also referred to as maturing. Typical maturing periods are 6 to 24 hours, preferably 12 to 24 hours.

### Stage 2

In the second stage, the constituents of the vulcanization system are incorporated into the rubber composition of the first stage, whereby a vulcanizable rubber composition according to the present invention is obtained.

If a zinc oxide-based vulcanization system is used as the vulcanization system, the zinc oxide and the other constituents such as sulfur in particular, and particularly preferably thiazole, are added in stage 2.

The highest temperatures obtained during the preparation of the admixture of the vulcanization system to the rubber composition in the second stage (“dump temperature”) should preferably not exceed 110° C., and particularly preferably not exceed 105° C. A preferred temperature range is between 90° C. and 110° C., particularly preferably 95° C. and 105° C. At temperatures above 105 to 110° C., premature vulcanization may occur.

After admixing the vulcanization system in stage 2, the composition is preferably cooled down.

In the above-mentioned two-stage method, a rubber composition according to the invention is thus first obtained in the first stage, which is supplemented in the second stage to form a vulcanizable rubber composition, in particular a vulcanizable rubber composition for inner liners.

### Method for Further Processing the Vulcanizable Rubber Composition According to the Invention

The vulcanizable rubber compositions obtained in the two-stage method described above are preferably further processed by calendering, extrusion or in the roller head process.

### Calendering

The vulcanizable rubber composition of the present invention is preferably fed to the calender in a first step (a), for example, using a preheating rolling mill and a downstream feeder rolling mill, or else in an extrusion process using an extruder. In both cases, the vulcanizable rubber composition should have a temperature of preferably 65° C. to 85° C., particularly preferably 70° C. to 80° C., before it is fed to the calender.

In the second step (b), calendering is carried out, wherein different roller positions of the preferably three or four rollers of the calender are possible. Preferably, calendering is carried out by means of a four-roll Z-type calender (“inclined Z calender”) or a four-roll L-type calender (“inverted L calender”). Herein, the cooler pick-up rolls preferably have a temperature of 75° C. to 85° C., while the warmer rolls preferably have a temperature of 85° C. to 95° C.

After calendering the calendered vulcanizable rubber composition leaves the calender as a calendered web in a third step (c) and is cooled, preferably to temperatures below 35° C., before following processing. When the calendered webs leave the calender, it is also possible to consolidate several calendered webs into a multilayer. Care must be taken to ensure that no undesirable air inclusions occur during the consolidation process.

Following the three steps, it is advantageous to store the calendered webs or the calendered webs consolidated into a multilayer for at least 3 hours, even better for at least 4 hours, preferably for at least 12 to 24 hours, in a fourth step (d). This storage serves for the complete cooling of the calendered webs and allows stress relaxation.

Calendering is preferably carried out at calendering speeds in the range of 20 to 35 m/min, particularly preferably 25 to 30 m/min.

### Extruding

Besides calendering, it is also possible to obtain inner liners by extrusion.

Feeding the vulcanizable rubber composition of the present invention to the extruder is preferably carried out in a first step (a), for example via a double-roll mixer or other suitable feeding devices. Here, the vulcanizable rubber composition should have a temperature of preferably 65° C. to 85° C., particularly preferably 70° C. to 80° C., before it is fed to the calender.

In the second step (b) of the extrusion, temperatures of 100° C. may be obtained. Therefore, special care must be taken to ensure that no scorching occurs.

After extrusion, the extruded vulcanizable rubber composition leaves the extruder as a web in a third step (c) and is cooled, preferably to temperatures below 35° C., before following processing. When the webs leave the extruder, multiple webs can also be consolidated into a multilayer. Care must be taken to ensure that no undesirable air inclusions occur during the consolidation process.

Following the three steps, it is advantageous to store the webs or the webs consolidated into a multilayer for at least 3 hours, even better for at least 4 hours, preferably for at least 12 to 24 hours, in a fourth step (d). This storage serves for the complete cooling of the webs and allows stress relaxation.

### Roller Head Process

In the roller head process, the calender nip of a two- or three-roll calender is fed with a rubber compound from an extruder with a preform head, in contrast to calendering with multiple rollers, as described above. The extruder itself can be fed with warm or cold feedstock. For example, it is possible to use a cold-fed pin extruder. The roller nip (calender nip) can be optimally fed, when the provided compound is matched with the web to be calendered in terms of thickness and width, which can be achieved by the choice of the preform head and the exchangeable shaping dies mounted on its end.

In terms of operating behavior, roller-headlines lie between extruders and calenders, wherein the uniform flow in the extruder die is decisive for the quality and dimension in the production of thicker webs, while calendering behavior is more important for thinner webs.

The operating temperatures are in the range of calendering and extrusion as described above for these processes.

As already described in connection with calendering, the finished webs must be cooled after leaving the calender according to step (c) above, which is preferably followed by step (d) above.

The vulcanizable webs that were calendered, extruded or obtained by the roller head process have a layer thickness of 0.3 to 5 mm, particularly preferably 0.4 to 4 mm, more particularly preferably 0.5 to 3 mm. These layer thickness ranges are typical for inner liners.

### Vulcanized Rubber Compositions

Also an object of the present invention are vulcanized rubber compositions which are obtainable from the vulcanizable rubber compositions described above, for example also by using a kit of parts.

The vulcanization conditions depend on the vulcanization system used. Suitable vulcanization temperatures are preferably from 140° C. to 200° C., particularly preferably from 150° C. to 180° C.

Preferably, the vulcanized rubber composition is the inner liner of a pneumatic tire.

### Properties of the Vulcanized Rubber Composition

The vulcanized rubber compositions obtained from the vulcanizable rubber compositions according to the invention preferably have
(a) a Shore A hardness in the range from 35 to 65, particularly preferably from 38 to 60 and more particularly preferably from 40 to 55; and/or
(b) a modulus 300 of from 2.8 MPa to 8 Pa, particularly preferably from 3.0 MPa to 6.0 MPa, and more particularly preferably from 3.0 MPa to 4.0 MPa; and/or
(c) a density of from 1.000 g/cm³ to 1.120 g/cm³, particularly preferably from 1.010 g/cm³ to 1.100 g/cm³ and more particularly preferably from 1.020 g/cm³ to 1.080 g/cm³; and/or
(d) a gas permeability of less than 3.8×10⁻¹⁷ m²/Pas, particularly preferably a gas permeability of 2.5×10⁻¹⁷ m²/Pas to 3.8×10⁻¹⁷ m²/Pas and more particularly preferably of 2.7×10⁻¹⁷ m²/Pas to 3.7×10⁻¹⁷ m²/Pas, such as for example 2.8×10⁻¹⁷ m²/Pas to 3.5×10⁻¹⁷ m²/Pas.

In general, a higher content of fillers F1 that can be used according to the invention, in particular HTT lignins and optionally other fillers, typically reduces the gas permeability further, but at the expense of the tear strength and elongation at tear of the compound. By partially replacing the fillers F1 with the industrial carbon blacks F2, both the tensile strength and the elongation at break can be greatly increased without the other properties worsening considerably.

### Method for Manufacturing a Pneumatic Tire Comprising an Inner Liner Made of the Vulcanizable Rubber Composition According to the Invention

The vulcanizable webs obtainable by the above methods are stored until use, preferably in the form of rolls, and serve as material for inner liners in the manufacture of pneumatic tires. For this purpose, the webs must be cut to drum circumference, which is possible by using ultrasonic knives or heatable rotating circular knives, with the latter preferably in the so-called roll-on-and-cut process.

The inner liners are typically vulcanized under pressure and/or heat, together with the tire carcass and/or the other tire components.

Suitable vulcanization temperatures are preferably from 140° C. to 200° C., particularly preferably from 150° C. to 180° C.

The process can be carried out, for example, in such a way that by closing the press, the tire blank is molded into the closing mound. For this purpose, an inner bellows (heating bellows) can be pressurized with a low pressure (<0.2 bar) so that the bellows also fits into the tire blank. After that, the press and thus the mound are completely closed. The pressure in the bellows is increased (to shaping pressure, usually approx. 1.8 bar). Thereby, the profile is imprinted into the tread, as well as the sidewall labelling. In the next processing step, the press is locked and the clamping force is applied. The clamping force varies depending on the press type and the tire size and may reach up to 2500 kN using hydraulic cylinders. After the closing forces have been applied, the actual vulcanization process starts. Here, the mold is continuously heated with steam from the outside, wherein the temperatures are usually set between 15° and 180° C. For the inner medium, there are widely differing variants, depending on the tire type. For example, steam or hot water is used inside the heating bellows. The internal pressures can vary and differ according to tire types, such as passenger car or truck tires.

All measured quantities mentioned in the present description in connection with the present invention are determined according to the procedures mentioned in the experimental part.

Use of the Fillers F1 to be Used According to the Invention, in Particular the HTT Lignins F1, as Well as Mixtures of F1 with F2

Another object of the present application is the use of the fillers F1 as defined above in connection with the rubber composition according to the invention, preferably the HTT lignins, or mixtures of the fillers F1 with the industrial carbon blacks F2, these also being defined as above, in rubber compositions for inner liners, wherein the fillers F1 and industrial carbon blacks F2 are used in a total amount of at least 46 phr.

The use is intended in particular to reduce gas permeability and crack growth, especially in comparison with rubber compositions containing industrial carbon black N660 and/or industrial carbon black N772 instead of F1 and/or F2.

### Examples

The constituents of the rubber composition, the non-vulcanized rubber composition and the vulcanized rubber composition were subjected to various test procedures, which will be described in more detail below.

### Characterization of Fillers F1 and F2

### Mass-Related Surface (BET Surface and STSA Surface)

The specific surface area of the HTT lignin was determined by nitrogen adsorption according to the ASTM D 6556 (2019 Jan. 1) standard provided for industrial carbon blacks. According to this standard, the BET surface area (specific total surface area according to Brunauer, Emmett and Teller) and the external surface area (STSA surface area; Statistical Thickness Surface Area) were determined as follows.

Prior to the measurement, the sample to be analyzed was dried to a dry matter content ≥97.5 wt. % at 105° C. In addition, the measuring cell was dried in a drying oven at 105° C. for several hours before weighing in the sample. The sample was then filled into the measuring cell using a funnel. In case of contamination of the upper measuring cell shaft during filling, it was cleaned using a suitable brush or a pipe cleaner. In the case of strongly flying (electrostatic) material, glass wool was weighed in additionally into the sample. The glass wool was used to retain any material that might fly up during the bake-out process and contaminate the unit.

The sample to be analyzed was baked out at 150° C. for 2 hours, and the Al₂O₃ standard was baked out at 350° C. for 1 hour.

The following N₂ dosage was used for the determination, depending on the pressure range:

$$p / p 0 = 0 - 0.01 : {N}_{2} dosage : 5 ml / g$$

$$p / p 0 = 0.01 - 0.5 : {N}_{2} dosage : 4 ml / g$$

To determine the BET, extrapolation was performed in the range of p/p0=0.05-0.3 with at least 6 measurement points. To determine the STSA, extrapolation was performed in the range of the layer thickness of the adsorbed N₂ from t=0.4-0.63 nm (corresponding to p/p0=0.2-0.5) with at least 7 measurement points.

### Determination of the pH Value

The pH was determined following ASTM D 1512 standard as described hereinafter. The dry sample, if not already in powder form, was mortared or ground to a powder. In each case, 5 g of sample and 50 g of fully de-ionized water were weighed into a glass beaker. The suspension was heated to a temperature of 60° C. with constant stirring using a magnetic stirrer with heating function and stirring flea, and the temperature was maintained at 60° C. for 30 min. Subsequently, the heating function of the stirrer was deactivated so that the mixture could cool down while stirring. After cooling, the evaporated water was replenished, by adding fully de-ionized water again and stirred again for 5 min. The pH value of the suspension was determined with a measuring instrument. The temperature of the suspension should be 23° C. (+0.5° C.). A duplicate determination was performed for each sample and the averaged value was reported.

### Determination of Bulk Density

The bulk density of the sample was determined following ISO 697 as described hereinafter. A standard beaker according to DIN ISO 60 (100 ml volume) for the determination of the bulk density was placed into a dish that collects the overflow. The beaker was filled to overflow using a funnel and a shovel. The surplus was scraped off with a straight edge of the shovel along the bord of the beaker. The beaker was wiped on the outside with a dry cloth and then weighed with 0.1 g accuracy.

### Determination of Acidic Hydroxy Groups Available on the Surface (OH Group Density)

The determination of the acidic hydroxy groups available on the surface was carried out qualitatively and quantitatively by colorimetry according to Sipponen. The method according to Sipponen is based on the adsorption of the alkaline dye Azure B to the acidic hydroxy groups accessible on the filler surface, and is described in detail in the paper “Determination of surface-accessible acidic hydroxyls and surface area of lignin by cation dye adsorption” (Bioresource Technology 169 (2014) 80-87). The amount of surface-available acidic hydroxy groups is given in mmol/g of filler. Regardless of how the filler was obtained, the process was applied not only to lignin-based fillers but also, for example, to the comparative carbon black N660.

### Determination of the ¹⁴C Content

The determination of the ¹⁴C content (content of biologically based carbon) can be carried out by means of the radiocarbon method according to DIN EN 16640:2017-08.

### Determination of the Particle Size Distribution

The particle size distribution can be determined by laser diffraction of the material dispersed in water (1% by weight in water) according to ISO 13320:2009, whereby the measurement is preceded by an ultrasonic treatment of 12000 Ws. The volume fraction is specified e.g. as Dᵥ(97) in μm (diameter of the particles of 97% of the volume of the sample is below this value). The same approach applies to the Dᵥ(50) value.

### Characterization of the Vulcanizable Rubber Compositions (“Green Compounds”)

### Determination of Reaction Kinetics/Vulcanization Kinetics

The reaction kinetics of non-vulcanized rubber compounds (“green compounds”) were determined by means of a rheometer MDR 3000 Professional (MonTech Werkstoffprüfmaschinen GmbH, Buchen, Germany) by determining the time course of the torque [dNm] according to DIN 53529 TI 3 (torsion shear rotorless curemeter). The upper and lower rotor plates of the rheometer were heated to 160° C. 5.5 g±0.5 g of the non-vulcanized rubber compositions were cut from the center of the sheet with scissors. Here, care was taken to ensure that the cut-out represented a square area and that the diagonal of this area corresponded to the diameter of the rotor of the rheometer. Before placing the non-vulcanized rubber composition on the rotor of the rheometer, the top and bottom of the cut-out were covered with a film. Immediately after inserting the non-vulcanized sample, the measurement was started.

The minimum and maximum torque (M_{L}, M_{H}) were determined from the measurement curves within a 30-minute test phase at 160° C. (0.5° arc, 1.67 Hz) and the difference Δ(M_{H}−M_{L}) was calculated therefrom.

Furthermore, for each of the measurement curves, the minimum torque ML was defined as 0% of the maximum torque MH and the maximum torque MH was normalized as 100%. Subsequently, the time periods were determined in which the torque, starting from the time of the minimum torque ML, reaches 10%, 50% and 90% of the maximum torque MH, respectively. The time periods were designated as T₁₀, T₅₀, and T₉₀.

### Characterization of the Vulcanized Rubber Compositions

### Determination of Shore A Hardness

The determination of the Shore A hardness of vulcanized rubber compositions was carried out in accordance with ISO 7619-1, using a digital Shore hardness tester from the company Sauter GmbH. Before each measurement, the instrument was calibrated with the accompanying calibration plate. For the measurement of hardness, three S2 bars, which were punched out for performing the tensile test according to DIN 53504, were placed on top of each other. Hardness measurements were carried out at five different locations on the stack. The Shore A hardness of vulcanized rubber compositions represents the mean value of the five measurements. Between vulcanization and testing, the sample was stored for at least 16 h at room temperature in the laboratory.

### Determination of the Density of the Vulcanized Rubber Composition

The determination of the density of the vulcanized rubber compositions was carried out according to DIN EN ISO 1183-1:2018-04 (Method for determining the density of non-cellular plastics) Method A (immersion method). Ethanol was used as the immersion medium. The density of the vulcanized rubber composition represents the mean value of a triple determination. Between vulcanization and testing, the sample was stored for at least 16 h at room temperature in the laboratory.

### Determination of Gas Permeability

The determination of the gas permeability of the vulcanized rubber composition to air was carried out according to ISO 15105. The measurements were carried out at 70° C. The gas permeability represents the mean value of three measurements. Between vulcanization and testing, the sample was stored for at least 16 h at room temperature in the laboratory.

### Determination of the Compression Set

Compression set was determined on vulcanized rubber compositions in accordance with DIN ISO 815-1:2016-09. Three test bodies were tested per sample. The exposure time was 22 h measured from the moment the compression set was placed in the heating cabinet. The test temperature was 70° C. The applied compressive stress was 25% of the initial thickness of the test body. The bodies were stored at room temperature for at least 16 h between vulcanization and testing.

### Determination of Tear Strength, Elongation at Tear and Stress Values (Moduli)

The tensile test is used to determine the tear strength, the elongation at tear and the stress values on non-preloaded bodies. In the tensile test, the bodies are stretched to the tear under constant strain rate and the force and change in length required for this are recorded.

Tear strength: The tear strength σR is the quotient of the force FR measured at the moment of tearing and the initial cross section A0 of the sample body.

Tensile strength: The tensile strength σmax is the quotient of the measured maximum force Fmax and the initial cross section A0 of the sample body. For elastomers, the force FR occurring during tearing is generally also the maximum force Fmax.

Elongation at tear: The elongation at tear εR is the quotient of the change in length LR−L0 measured at the moment of tearing and the originally measured length L0 of the sample body. It is expressed as a percentage. For the sample bars used, L0 is the specified distance between two measuring marks.

Stress value: The stress value oi is the tensile force Fi present when a certain elongation is reached, related to the initial cross section A0. For sample bars, the strain is related to the originally measured length L0, i.e., the specified distance between the measuring marks.

The determination of tensile strength, elongation at tear and stress values of the vulcanized rubber composition was carried out in accordance with ISO 37 using a testing instrument of the Tensor Check type from the company Gibitre Instruments. Between vulcanization and testing, the sample was stored for at least 16 h at room temperature in the laboratory. To determine the modulus, at least five dumbbell test samples were punched out of the vulcanized rubber composition with the body dimensions listed in ISO 37 (rod type S2). The thickness of the sample body was determined using a calibrated thickness gauge from the company Käfer Messuhren, and it represents the mean value of three measurements taken at different positions on the bridge portion. The crosshead speed during the tensile test was 200 mm/min. The stated measurement values given for tensile strength, elongation at break and stress values (moduli 100, 200, 300) are mean values from five measurements.

### De Mattia Crack Growth Test According to DIN 53522

In the fatigue bending test to assess the resistance of an elastomer to crack growth, dynamic testing is carried out using a De Mattia test device. The test body (140×25×6.3 mm) has a transverse groove and is deformed by compression using an eccentric. There are 300 bending cycles per minute, whereby the test bodies are bended to 40% of the clamping length. The test bodies are pierced in the middle of the groove with a cutting tool described in the standard, whereby a 2 mm crack is created before the test starts. The test is continued until the crack length has changed significantly. The number of cycles is noted up to a certain extension of the crack.

Volume Swelling with Toluene and Calculation of the M_{c}

Cross-linked polymers swell in solvent (LM) to a certain equilibrium value, which is a function of the degree of cross-linking. This can be determined via swelling elongation.

The swelling behavior of elastomers can thus be used to determine the average molecular network arc length Mc, which is one of the most important structural parameters of a polymer network. This parameter is decisive for the mechanical properties of elastomers.

M_{c} is obtained from the relation: M_{c}=A/B*q^{5/3}
M_{c}=average molar mass between two cross-linking locations
A=density of the rubber*molecular volume of solvent
B=0.5—Flory-Huggins constant (here 0.35)
q=degree of swelling

The degree of swelling q corresponds to the reciprocal value of the volume fraction q=1/v₂. The value v₂ is calculated from the following equation: v₂=1/(1+V₁/V₀), wherein V₁ is the volume of the solvent and V0 is the volume of the unswollen rubber. The ratio V₁/V₀ is calculated using the following equation:

$${V}_{1} / {V}_{0} = ( {m}_{q} - {m}_{0} ) / {ρ}_{L} / {m}_{0} / ρ$$

m_{q}=mass of the swollen rubber
m₀=mass of the rubber before swelling
   ρ_{L}=Density of the solvent
   ρ=Density of the rubber.

### Examples for Preparation

### Preparation of the HTT Lignins Usable According to the Invention

The three fillers F1A, F1B and F1C derived from renewable raw resources could be characterized as indicated in Table 1. The results of the characterization were compared with the commercially available and ASTM standardized industrial carbon black types N660, N772 and N326.

The fillers F1A, F1B and F1C were produced by hydrothermal treatment of lignin, as described in detail in WO 2017/085278 A1.

A lignin-containing liquid was prepared for this purpose. First, water and lignin were mixed and a lignin-containing liquid with a dry organic matter content of 15% by weight was prepared. The lignin was then predominantly dissolved in the lignin-containing liquid. For this purpose, the pH value was adjusted by adding NaOH. The preparation of the solution was supported by intensive mixing at 80° C. for 3 hours. The lignin-containing liquid was then subjected to hydrothermal treatment to obtain a solid. The prepared solution was heated at 2 K/min to the reaction temperature of 220° C., which was maintained over a reaction period of 8 hours. This was followed by cooling. As a result, an aqueous solid suspension was obtained. The solids were largely dewatered and washed by filtration and washing. The subsequent drying and thermal treatment was carried out under nitrogen in a fluidized bed, whereby the drying process was heated to a temperature of 50° C. at 1.5 K/min and held for 2.5 h and then heated to a temperature of 190° C. at 1.5 K/min for the thermal treatment, held for 15 min and cooled again. The dried solid was de-agglomerated on a counter jet mill with nitrogen to a Dᵥ(97) value (determined according to the determination method described above), up to the particle size given in Table 1.

TABLE 1

| Test | | Unit | F1A | F1B | F1C | N660 | N772 | N326 |
|---|---|---|---|---|---|---|---|---|
| STSA | | m²/g | 51.6 | 44.7 | 46.2 | 34 | 28 | 76 |
| BET | | m²/g | 55.5 | 49.1 | 51.4 | 35 | 29 | 78 |
| Particle size | Dᵥ(97) | μm | 4.2 | 4.0 | 6.5 | | | |
| distribution | Dᵥ(50) | μm | 1.5 | 1.1 | 1.6 | | | |

| | | | | | | | |
|---|---|---|---|---|---|---|---|
| OH-hroup-density¹ | mmol/g | 0.31 | 0.32 | 0.17 | | | |
| Carbon content | [%] | 72.7 | 71.2 | 70.6 | >98 | >98 | >98 |
| Oxygen content | [%] | 20.7 | 22.2 | 22.1 | <1 | <1 | <1 |
| Density | g/cm³ | 1.32 | 1.33 | 1.32 | 1.8 | 1.8 | 1.8 |
| pH-value | — | 9.0 | 8.7 | 8.8 | 9.1 | 9.7 | 9.5 |
| ¹⁴C-content | Bq/g C | 0.23 | 0.23 | 0.23 | <0.04 | <0.04 | <0.04 |

¹= Surface-available acidic hydroxy groups

### Preparation of Different Rubber Compositions (Stage 1)

In a Haake Rheomix 3000 S mixer, equipped with Banbury rotors, from the company ThermoFischer, rubber compositions (base compounds; masterbatches) were prepared as follows, with the constituents and amounts given in Table 2.

Before mixing started, the mixing chamber was heated to 40° C. The amounts of the constituents were calculated in each case to give a mixing chamber filling level of 70%. All constituents were pre-weighed on a scale from the company Kern. After starting the rotors (50 rpm), the mixing chamber was charged with rubber, the filling device leading to the mixing chamber was pneumatically locked, and mixing was carried out to a total mixing time of 1 minute. After that, the filling device of the mixing chamber was opened, ⅓ of the filler amount and additives (0.15 phr MgO; 4 phr Escorez 1102) were added, the mixing chamber was closed again and mixing was carried out up to a total mixing time of 2 minutes. The filler of the mixing chamber was then opened, ⅙ of the filler amount, followed by ½ of the oil amount, followed by ⅙ of the filler amount was added, the mixing chamber was closed again and mixing was carried out up to a total mixing time of 4 minutes. Then, the filling device of the mixing chamber was opened, ⅙ of the filler amount, followed by ½ of the oil amount, followed by ⅙ of the filler amount added, the mixing chamber was closed again, and mixing was carried out up to a total mixing time of 6 minutes. The chamber was aerated after 8 minutes of total mixing time. The ejection temperature was controlled by regulating the speed. Ejection occurred after a total mixing time of 10 minutes, and the temperature of the compound was measured.

After the mixing process, the compound was taken from the mixer and cooled and homogenized on a laboratory rolling mill at medium nip width. For this purpose, the compound was first passed through the roller nip once, the resulting compound sheet was rolled into a “doll” and plunged overhead through the roller nip six times. The sheet was then placed on the cooling table to cool until the sheet had reached room temperature.

TABLE 2

| | EXAMPLES [amounts in phr] | | |
|---|---|---|---|
| Constituents | V1 | V2 | B1 |
| BIIR 2230¹ | 100 | 100 | 100 |
| Carbon black | 60 | — | — |
| N660² | | | |
| F1A | — | 45 | 52 |
| Processing oil³ | 8 | 8 | 8 |
| Stearic acid | 1 | 1 | 1 |
| Total amount | 169 | 154 | 161 |
| Tₘₐₓ^{#} [in ° C.] | 109 | 104 | 117 |

¹Bromobutyl rubber X Butyl BB 2230 from the company Arlanxeo
²Carbon black N660 from the company Lehmann und Voss
³Paraffin oil from the company Hansen und Rosenthal Tudalen 1927
^{#}Highest temperature reached during mixing (“dumping temperature”)

Comparative Example V1 differs from Example B1 according to the invention in that industrial carbon black N660 was used in this example. In comparative example V2, the maximum amount of F1A in phr was used, which would be permissible for HTT lignin according to the teachings of WO 2020/202125 A1.

### Preparation of Vulcanizable Rubber Compositions (Stage 2)

The vulcanizable “green compounds” of Examples V1, V2 and B1 were prepared for each of the rubber compositions by admixing a vulcanization system consisting of 1 phr zinc oxide, 0.5 phr sulfur and 1.9 phr mercaptobenzothiazyl disulfide (80%; comprises 20% by weight binding and dispersing agents). In Comparative Example V1, the zinc oxide was already added in step 1.

First, the cooled compound sheet was cut into strips and the vulcanization chemicals were weighed out. After starting the rotors (50 rpm) at 40° C. mixing chamber temperature, the sheet was fed to the mixing chamber, the filling device to the mixing chamber was pneumatically locked and mixing was carried out up to a total mixing time of 2 minutes. Subsequently, the filling device to the mixing chamber was opened, vulcanization chemicals were added, the filling device to the mixing chamber was pneumatically locked, and mixing was performed up to a total mixing time of 5 minutes. The ejection temperature was controlled by regulating the speed. Ejection occurred after a total mixing time of 5 minutes, and the temperature of the compound was measured.

After the mixing process, the compound was taken from the mixer and cooled and homogenized on a laboratory rolling mill at medium nip width. For this purpose, the mixture was first passed through the roller nip once, the resulting compound sheet was rolled into a “doll” and plunged overhead through the roller nip six times. The sheet was then placed on the cooling table to cool until the sheet had reached room temperature.

From this resulted the vulcanizable compositions V1_{g} and V2_{g} and B1_{g}, wherein “g” stands for “Green Compound” and the remaining designation corresponds to Examples V1, V2 and B1.

### Preparation of the Vulcanized Rubber Compositions

From the vulcanizable rubber compositions V1_{g} and V2_{g} and B1_{g}, completely vulcanized test samples V1ᵥ and V2ᵥ and B1ᵥ, corresponding to the vulcanizable green compounds V1_{g} and V2_{g} and B1_{g}, were obtained by vulcanization at 160° C. in vulcanizing presses. The compound sheet was rolled out without wrinkles to a thickness of 3 mm, by successively reducing the nip width of the laboratory roller. A square with dimensions of 250×250 mm was then cut from this sheet with scissors and transferred to the press (Gibitre Instruments S.R.L. vulcanization press, with built-in mold for test plates of 2 mm thickness). The vulcanization time to be set results from the t90 time determined in the rheometer test plus one minute per millimeter of sheet thickness (i.e., plus two when using the 2 mm frame). The vulcanized rubber mat was removed immediately after the pressing time had elapsed. The mat was placed on the cooling table for cooling. After cooling, the protruding edge was carefully cut off with scissors.

### Further Rubber Compositions Comprising Filler F1B

The vulcanizable rubber compositions listed in Table 3 were prepared in the same way as described above. In contrast to Table 2, in Table 3 the rubber compositions including the components added in stage 2 and their quantities were specified (i.e. as “green compounds”).

TABLE 3

| | EXAMPLES [amounts in phr] | | | | | | | |
|---|---|---|---|---|---|---|---|---|
| Constituents | V3_{g} | V4_{g} | B2_{g} | V5_{g} | V6_{g} | B3_{g} | V7_{g} | B4_{g} |
| BIIR 2230 | 100 | 100 | 100 | 100 | 100 | 100 | 100 | 100 |
| Carbon black N660 | 60 | — | — | 10 | — | — | — | — |
| Carbon black N772 | — | — | — | — | 10 | — | 15 | — |
| Carbon black N236 | — | — | — | — | — | 10 | — | 15 |
| F1B | — | 45 | 52 | 40 | 40 | 40 | 40 | 40 |
| Processing oil | 8 | 8 | 8 | 8 | 8 | 8 | 12 | 12 |
| Struktol 40 MS | 5 | 5 | 5 | 5 | 5 | 5 | 5 | 5 |
| Escorez 1102 | 4 | 4 | 4 | 4 | 4 | 4 | 4 | 4 |
| Zinc stearate | — | — | — | 1 | 1 | 1 | 1 | 1 |
| Stearic acid | 1 | 1 | 1 | 1 | 1 | 1 | 1 | 1 |
| MgO | 0.15 | 0.15 | 0.15 | 0.15 | 0.15 | 0.15 | 0.15 | 0.15 |
| ZnO | 1 | 1 | 1 | 1 | 1 | 1 | 1 | 1 |
| Sulfur | 0.5 | 0.5 | 0.5 | 0.5 | 0.5 | 0.5 | 0.5 | 0.5 |
| MBTS (80%) | 1.9 | 1.9 | 1.9 | 1.9 | 1.9 | 1.9 | 1.9 | 1.9 |
| Total amount | 181.5 | 166.5 | 173.5 | 172.5 | 172.5 | 172.5 | 181.5 | 181.5 |
| Tₘₐₓ [in ° C.] | 110 | 110 | 110 | 110 | 110 | 110 | 110 | 110 |

Examples V3_{g}, V4_{g} and B2_{g} correspond to examples V1_{g}, V2_{g} and B1_{g} (i.e. the “green compounds” of examples V1, V2 and B1) with the difference that filler F1B was used instead of filler F1A. F1B has a slightly lower multi-point BET surface area and a slightly lower STSA surface area (see Table 1).

In the examples V5_{g}, V6_{g} and B3_{g}, part of the filler F1B was replaced by carbon blacks with different BET or STSA surfaces. The ratio of FB1 to carbon black is 40:10.

In the examples V7_{g} and B4_{g}, part of the filler F1B was replaced by carbon blacks with different BET or STSA surfaces. The ratio of FB1 to carbon black is 40:15. The content of process oil was also increased slightly.

### Further Rubber Compositions Comprising Filler F1C

The vulcanizable rubber compositions listed in Table 4 were produced in the same way as described above. The presentation in Table 4 is analogous to that in Table 3.

TABLE 4

| | EXAMPLES [amounts in phr] | | | | |
|---|---|---|---|---|---|
| Constituents | I_{g} | II_{g} | III_{g} | IV_{g} | V_{g} |
| X Butyl BB 2030 | 100 | 100 | 80 | — | — |
| X Butyl CB 1240 | — | — | — | 80 | 80 |
| SMR CV (natural rubber) | — | — | 20 | 20 | 20 |
| Carbon black N660 | 60 | — | — | — | — |
| F1C | — | 50 | 50 | 50 | 55 |
| Processing oil (Tudalen | 8 | 8 | — | — | — |
| 1927) | | | | | |
| Processing oil (Pionier | — | — | 8 | 8 | 8 |
| TP 130C) | | | | | |
| Struktol 40 MS | 5 | 5 | 5 | 5 | 5 |
| Escorez 1102 | 4 | 4 | 4 | 4 | 4 |
| Stearic acid (Palmera | 1 | 1 | 1 | 1 | 1 |
| B1805) | | | | | |
| MgO | 0.15 | 0.15 | — | — | — |
| ZnO | 3 | 3 | 3 | 3 | 3 |
| Sulfur (Struktol SU 95) | 0.5 | 0.5 | 0.5 | 0.5 | 0.5 |
| MBTS (80%-ig) | 1.9 | 1.9 | 1.9 | 1.9 | 1.9 |
| Avorator TMTD-80 | — | — | 0.375 | 0.375 | 0.375 |
| Total amount | 183.55 | 173.55 | 173.775 | 173.775 | 178.775 |
| Tₘₐₓ [in ° C.] | 110 | 110 | 110 | 110 | 110 |

The above examples in Table 4 show that blends of bromobutyl rubber (X Butyl BB 2030) or chlorobutyl rubber (X Butyl CB 1240) with natural rubber (SMR CV) can also be produced using the filler F1C. Due to the advantages of using F1 fillers in bromobutyl rubber with regard to reducing gas permeability as described in the results section, it is possible to replace part of the bromobutyl rubber with natural rubber, which is somewhat more gas-permeable but has the advantage of being a product of biological origin, while maintaining sufficiently good gas permeability. By increasing the amount of F1c, the advantages associated with the filler F1 can also be improved. The crosslinking chemicals have been adapted so that they are suitable for blending with natural rubber.

### Test Results

In Table 5, the test results for the reaction kinetics/vulcanization kinetics of the vulcanizable rubber compositions V1_{g}, V2_{g} and B1_{g} (using filler F1A) and V3_{g}, V4_{g} and B2_{g} (using filler F1B) are reported.

TABLE 5

| Measured | | | | | | | |
|---|---|---|---|---|---|---|---|
| variable | Unit | V1_{g} | V2_{g} | B1_{g} | V3_{g} | V4_{g} | B2_{g} |
| M_{L} | dNm | 1.28 | 1.65 | 1.93 | 1.50 | 1.85 | 1.92 |
| M_{H} | dNm | 5.68 | 5.28 | 6.02 | 6.24 | 6.48 | 6.86 |
| Δ(M_{H} − M_{L}) | dNm | 4.40 | 3.63 | 4.09 | 4.74 | 4.63 | 4.94 |
| T₁₀ | min | 2.75 | 2.29 | 2.23 | 3.05 | 3.75 | 3.49 |
| T₅₀ | min | 7.50 | 10.71 | 10.68 | 8.63 | 20.41 | 17.43 |
| T₉₀ | min | 15.36 | 24.92 | 25.03 | 17.59 | 57.19 | 47.19 |

As can be seen in Table 5, the data for the reference mixtures with carbon black N660 V1_{g} and V3_{g} are within a tolerable range. However, there are significant deviations in the reaction kinetics for V4_{g} and B2_{g}. The technical literature on BIIR crosslinking using ZnO notes that water acts as a strong retarder. The HTT lignin used reaches equilibrium at a water uptake of around 2.5%. This is significantly higher than the water absorbed by carbon black N660. The influences of the reaction kinetics were taken into account during vulcanization by vulcanizing the test bodies of the respective mixtures with the time determined for T90.

Table 6 shows the measured values obtained on the vulcanized test sample bodies for the comparative examples V1ᵥ, V2ᵥ and the inventive example B1ᵥ.

TABLE 6

| Measured variable | Unit | V1ᵥ | V2ᵥ | B1ᵥ |
|---|---|---|---|---|
| Shore A hardness | — | 52 | 46 | 50 |
| Density | g/cm³ | 1.120 | 1.019 | 1.027 |
| Gas permeability | 10⁻¹⁷ m²/Pas | 3.88 | 3.15 | 2.91 |
| Compression set 22 h 70° C. | % | 42.7 | 36.8 | 36.6 |
| Modulus 100 | MPa | 1.0 | 0.7 | 0.9 |
| Modulus 200 | MPa | 2.1 | 1.3 | 1.8 |
| Modulus 300 | MPa | 3.5 | 2.4 | 3.3 |
| Modulus 300/Modulus 100 | — | 3.5 | 3.4 | 3.7 |
| Tensile strength | MPa | 10.9 | 8.1 | 8.4 |
| Elongation at failure | % | 727 | 665 | 569 |

As can be seen in Table 6, the gas permeability is improved when HTT lignin is used, even with a dosage of the same volume (taking into account the low density of the filler). A slight increase in the volume fill level, as with B1ᵥ, leads to an improvement in gas permeability of around 25%. With B1ᵥ, the reinforcement index M300/M100 is also improved. The values for tensile strength and elongation at break are within an acceptable range for the application of the compound in the inner liner.

Table 7 shows the measured values obtained on the vulcanized test specimens for the comparative examples V3ᵥ, V4ᵥ and the example B2ᵥ according to the invention.

TABLE 7

| Measured variable | Unit | V3ᵥ | V4ᵥ | B2ᵥ |
|---|---|---|---|---|
| Shore A hardness | — | 46 | 40 | 43 |
| Density | g/cm³ | 1.127 | 1.030 | 1.039 |
| average molar mass between | g/mol | 1160 | 1017 | 948 |
| two cross-linking locations M_{c} | | | | |
| Modulus 100 | MPa | 0.82 | 0.89 | 0.96 |
| Modulus 200 | MPa | 1.53 | 1.94 | 2.15 |
| Modulus 300 | MPa | 2.42 | 3.12 | 3.48 |
| Modulus 300/Modulus 100 | — | 2.96 | 3.51 | 3.63 |
| Tensile strength | MPa | 9.33 | 5.62 | 6.59 |
| Elongation at failure | % | 956 | 550 | 562 |
| DeMattia crack growth | mm | 13.5 | 13.4 | 11.6 |
| (1024000 Cycles) | | | | |

As can be seen in Table 7, the density of compounds V4ᵥ and B2ᵥ is lower when HTT lignin is used. The reinforcement properties up to 300% elongation are higher than those of the carbon black reference, which is also clearly shown in the reinforcement index M300/M100. It is also significant that the average molecular network arc length Mc, determined by toluene swelling using the Flory-Huggins constant (0.35), is slightly lower. Despite the higher network density and the higher moduli up to 300% deformation, B2ᵥ in particular shows that the inhibition of crack growth is improved. This is all the more remarkable as this compound with HTT lignin is subject to higher forces at the crack location.

TABLE 8

| Measured | | | | | | |
|---|---|---|---|---|---|---|
| variable | Unit | V5_{g} | V6_{g} | B3_{g} | V7_{g} | B4_{g} |
| M_{L} | dNm | 1.87 | 1.79 | 1.73 | 1.61 | 1.68 |
| M_{H} | dNm | 6.57 | 5.95 | 6.58 | 5.71 | 6.34 |
| Δ(M_{H} − M_{L}) | dNm | 4.70 | 4.16 | 4.85 | 4.10 | 4.66 |
| T₁₀ | min | 3.86 | 3.68 | 3.27 | 3.46 | 3.40 |
| T₅₀ | min | 18.40 | 18.25 | 15.76 | 15.00 | 16.55 |
| T₉₀ | min | 47.83 | 47.74 | 40.35 | 35.20 | 41.83 |

As can be seen in Table 8, the replacement of N772 with N326 shows a higher torque delta (M_{H}−M_{L}) for both dosages when measuring the crosslinking kinetics, which indicates a higher reinforcement effect. M_{L}, on the other hand, is hardly affected at these dosages, which indicates good processability for N326.

TABLE 9

| Measured variable | Unit | V6_{g} | B3_{g} | V7_{g} | B4_{g} |
|---|---|---|---|---|---|
| Shore A hardness | — | 40 | 42 | 40 | 42 |
| Density | g/cm³ | 1.048 | 1.049 | 1.060 | 1.058 |
| average molar mass | g/mol | 1116 | 963 | 1001 | 975 |
| between two cross- | | | | | |
| linking locations M_{c} | | | | | |
| Modulus 100 | MPa | 0.83 | 0.85 | 0.81 | 0.86 |
| Modulus 200 | MPa | 1.77 | 1.83 | 1.69 | 1.84 |
| Modulus 300 | MPa | 2.89 | 3.04 | 2.78 | 3.00 |
| Modulus 300/Modulus | — | 3.48 | 3.58 | 3.43 | 3.49 |
| 100 | | | | | |
| Tensile strength | MPa | 6.09 | 7.81 | 6.14 | 6.94 |
| Elongation at failure | % | 607 | 703 | 616 | 638 |
| DeMattia crack growth | mm | 14.2 | 12.8 | 10.0 | 10.3 |
| (1024000 Cycles) | | | | | |

As can be seen in Table 9, the replacement of carbon black N772 with carbon black N326 shows an increase in the stress values (modulus 100-300), tensile strength, elongation at break and hardness. What is particularly surprising, however, is that despite these higher stress values, an improvement in crack growth was achieved.

1. A rubber composition, comprising:
a rubber component, which comprises at least one halobutyl rubber selected from the group consisting of: bromobutyl rubber and chlorobutyl rubber, and
a filler component, which comprises one or more fillers F1 that have:
a ¹⁴C content in the range of 0.20 to 0.45 Bq/g of carbon;
a carbon content in the range of 60 wt. % to 85 wt. % relative to the ash-free and water-free filler;
acidic hydroxy groups on their surface;
wherein a weighted arithmetic average of statistical thickness surface areas (STSAs) of the fillers F1 is in a range from 40 m²/g to 80 m²/g;
the fillers F1 have a volume-based median particle size distribution Dᵥ(50) in a range from 0.5 μm to 5 μm and a volume-based Dᵥ(97) value in a range from 3 μm to 23 μm; and
(i) the filler component comprises more than 45 phr of the fillers F1; or
(ii) the filler component comprises more than 25 phr of the fillers F1 and additionally comprises one or more industrial carbon blacks F2, wherein a weighted arithmetic average of statistical thickness surface areas (STSAs) of the industrial carbon blacks F2 is in a range of 55 m²/g to 95 m²/g;
wherein an amount of halobutyl rubber in the rubber composition is 60 to 100 phr.

2. The rubber composition according to claim 1, wherein the STSA of each filler F1 is in a range from 40 m²/g to 80 m²/g and the STSA of each industrial carbon black F2 is in a range from 55 m²/g to 95 m²/g.

3. The rubber composition according to claim 1 comprising one or more further constituents selected from the group consisting of:
(i) rubbers that differ from halobutyl rubbers,
(ii) fillers F3 that differ from the filler F1 and the industrial carbon black F2,
(iii) softening agents,
(iv) adhesion-enhancing resins, and
(v) additives promoting vulcanization.

4. The rubber composition according to claim 3, wherein:
(i) the rubbers that differ from the halobutyl rubbers are selected from the group consisting of; natural rubber, butyl rubber and styrene-butadiene rubber, and/or
(ii) the fillers F3 that differ from the filler F1 and the industrial carbon black F2 are selected from the group of; carbon blacks and phyllosilicates, and/or
(iii) the softening agents are selected from the group consisting of: esters of aliphatic dicarboxylic acids, paraffinic oils and naphthenic oils, and/or
(iv) the adhesion-enhancing resins are selected from the group consisting of: aliphatic hydrocarbon resins, aromatic hydrocarbon resins, phenolic resins, phenol formaldehyde resins and phenol acetylene resins; and/or
(v) the additives promoting vulcanization are selected from the group of: saturated fatty acids with 12 to 24 carbon atoms and of thiazoles.

5. The rubber composition according to claim 3 wherein:
(i) the rubbers that differ from halobutyl rubbers are contained in the rubber composition in an amount of 0 to 40 phr, and/or
(ii) the fillers F3 that differ from the filler F1 and the industrial carbon black F2 are contained in the rubber composition in an amount of 0 to 40 phr, and/or
(iii) the softening agents are contained in the rubber composition in an amount of 0 to 20 phr, and/or
(iv) the adhesion-enhancing resins are contained in the rubber composition in an amount of 0 to 15 phr; and/or
(v) the additives promoting vulcanization are contained in the rubber composition in an amount of 0 to 5 phr.

6. The rubber composition according to claim 1, wherein the filler F1 is a lignin-based filler, optionally being a hydrothermally treated lignin.

7. The rubber composition according to claim 1, wherein the one or more fillers F1 are present in an amount of 50 to 100 wt.-% based on a total amount of the fillers F1 and the industrial carbon black F2 and/or the total amount of the F1 and the F2 is at least 46 phr.

8. The rubber composition according to claim 1, wherein an amount of surface-available acidic hydroxy groups of the fillers F1 is in a range from 0.05 mmol/g to 5 mmol/g.

9. A vulcanizable rubber composition, comprising: a rubber composition according to claim 1 and a vulcanization system comprising zinc oxide and/or sulfur.

10. The vulcanizable rubber composition according to claim 9, wherein the vulcanization system is selected from the group of: the following vulcanization systems comprising zinc oxide and
(a) at least one saturated fatty acid having 12 to 24 carbon atoms;
(b) at least one thiuram and/or dithiocarbamate, and preferably no sulfur;
(c) at least one alkyl phenoldisulfide;
(d) at least polymethylolphenol resin or a halogenated polymethylolphenol resin, and preferably no sulfur and no sulfur-containing compounds;
(e) sulfur and at least one thiazole and/or sulfenamide;
(f) sulfur, at least one thiazole and/or sulfenamide, and at least one saturated fatty acid having 12 to 24 carbon atoms.

11. A kit of parts, comprising, in spatially separated form, a rubber composition (A) according to claim 1 and a vulcanization system (B) comprising zinc oxide and/or sulfur.

12. A method for preparing a rubber composition as defined according to claim 1, comprising: providing the rubber component, and incorporating the filler component, and optionally softening agents, adhesion-enhancing resins and additives promoting vulcanization, therein.

13. A method for preparing a vulcanizable rubber composition according to claim 9, comprising: in a first stage, preparing by providing the rubber composition; incorporating the filler component, and optionally softening agents, adhesion-enhancing resins and additives promoting vulcanization, therein, and subsequently, in a second stage, admixing of the vulcanization system comprising zinc oxide and/or sulfur.

14. The method of claim 13, wherein the vulcanizable rubber composition is formed into a web by calendering, extrusion or in the roller head process.

15. The method according to claim 14, wherein the web has a thickness in the range of 0.3 to 5 mm.

16. The method of claim 14 further comprising: a step of cutting to size the web to an inner liner of pneumatic tires, and a subsequent step of vulcanizing the inner liner thus obtained together with a carcass of a pneumatic tire.

17. A method comprising: obtaining one or more fillers F1 optionally in admixture with one or more industrial carbon blacks F2, as defined in one claim 1, in rubber compositions for inner liners of pneumatic tires, wherein the fillers F1 and the industrial carbon blacks F2 are used in a total amount of at least 46 phr.

18. A vulcanized rubber composition, obtainable by vulcanizing a vulcanizable rubber composition according to claim 9.

19. The vulcanized rubber composition according to claim 18, comprising:
(a) a Shore A hardness in the range from 35 to 65, and/or
(b) a modulus 300 of 2.8 MPa to 8 MPa; and/or
(c) a density of 1.000 g/cm³ to 1.120 g/cm³; and/or
(d) a gas permeability of less than 3.8×10⁻¹⁷ m²/Pas.

20. The vulcanized rubber composition according to claim 18, wherein it is the inner liner of a pneumatic tire.
